(19) United States
(12) Patent Application Publication
(10) Pub. No.: US 2011/0258101 A1
(43) Pub. Date: Oct. 20, 2011

(54) METHODS AND SYSTEMS FOR LOSS MITIGATION, ACQUISITION AND DISPOSAL OF REAL-ESTATE ASSETS

(75) Inventors: James Edward Albertelli, Jacksonville, FL (US); Jonathan David Sawyer, Jacksonville, FL (US)

(73) Assignee: PREO, LLC, Jacksonville, FL (US)

(21) Appl. No.: 12/761,263

(22) Filed: Apr. 15, 2010

(51) Int. Cl. G06Q 50/00; G06Q 40/00

(52) U.S. Cl. 705/37; 705/38; 705/316

(57) ABSTRACT

In one embodiment, a method of loss mitigation and disposal of real estate related assets. The method comprises receiving and storing at least minimum bid and location information from a lender having an interest in the property that is to be disposed, receiving and storing an offer to purchase at least one property selected from the at least one property that is to be disposed from a prospective purchaser, receiving and storing information regarding a deposit provided to lender if offer to purchase at least one property is accepted by lender, marketing the at least one property that is to be disposed of to prospective purchasers and contacting the present owner of the at least one property that is to be disposed requesting formation regarding whether the present owner desires a loan modification, short sale, payment in exchange for keys of the at least one property that is to be disposed of.

### BACKGROUND

1. Field

The present disclosure provides methods and systems for the disposition of non-performing and performing real estate assets. More specifically, methods and systems are provided for loss mitigation, acquisition and disposal of non-performing assets.

2. General Background

Presently, due to various negative economic factors, including historically high levels of unemployment, there is a significant amount of non-performing assets in the marketplace. For example, due in part to the high unemployment rate, the amount and percentage of single-family home foreclosures is at a high not seen in many years. The problem seems to be worsening as mortgage default rates are on the rise, causing the banks to have more and more non-performing assets on their balance sheets. A non-performing asset is typically considered a loan or lease that is not meeting its stated payments. More broadly, a non-performing asset is considered an asset that is not producing income.

Presently, when a borrower does not pay his or her mortgage on their asset (e.g., home), the lender, typically a bank, goes through the foreclosure process to collect on their debt. As part of the foreclosure process, the asset is auctioned off, typically at the courthouse steps, to the highest bidder. The lender can set the minimum bid price for the asset, which it usually sets as the amount of debt it is owed plus any interest and penalties due to the lender. Often times, the value of the asset is less than what the amount of remaining debt the lender has on the property, causing the minimum bid to be higher than the present fair market value of the property. As a result, the asset does not receive any bids at or above the minimum bid price and the asset goes back to the lender. An asset that goes back to the lender after an unsuccessful foreclosure auction is owned by the lender and often called an REO (Real Estate Owned) asset. The foreclosure action is often unsuccessful for a number of reasons. First, the buyer of the asset must purchase the entire asset, often hundreds of thousands of dollars, in cash and cannot finance any portion of the purchase. As a result, a very large number of potential buyers who would purchase the asset with financing are prevented from being able to purchase the asset. Second, in order to purchase the property, a title search and analysis needs to be performed on the asset to ensure no encumbrances or other defects that exist in title that could significantly affect the properties value. Third, of the many properties that are supposed to be auctioned off at the foreclosure action, a significant amount of them are postponed to a later time. Fourth, there is little to no information regarding the condition, occupancy or other factors affecting the value of the property, making valuation of the asset more difficult. Finally, the foreclosure action process is often confusing and disorganized, making it difficult and undesirable for buyers to participate in the process. These and other reasons result in the foreclosure auction process being very inefficient and ineffective, causing the lender to have a larger percentage of failed foreclosure auctions, incur additional costs and expenses associated with keeping and disposing of the asset and, ultimately, receive less for the asset than they would in an efficient and effective system. The present disclosure solves these problems and provides various related advantages.

### SUMMARY

In one embodiment, a method of loss mitigation and disposal of real estate related assets. The method comprises receiving and storing at least minimum bid and location information from a lender having an interest in the property that is to be disposed, receiving and storing an offer to purchase at least one property selected from the at least one property that is to be disposed from a prospective purchaser, receiving and storing information regarding a deposit provided to lender if offer to purchase at least one property is accepted by lender, marketing the at least one property that is to be disposed of to prospective purchasers and contacting the present owner of the at least one property that is to be disposed requesting formation regarding whether the present owner desires a loan modification, short sale, payment in exchange for keys of the at least one property that is to be disposed of.

In another embodiment, a method of loss mitigation and disposal of real-estate related assets is provided. The method comprises (a) receiving and storing on a computer readable medium at least minimum bid and location information regarding at least one property that is to be disposed of from a lender having an interest in the property that is to be disposed, (b) receiving and storing on a computer readable medium an offer to purchase at least one property selected from the at least one property that is to be disposed from a prospective purchaser, (c) receiving and storing on a computer readable medium information regarding a deposit provided to lender if offer to purchase at least one property is accepted by lender, (d) electronically providing information to the lender regarding the offer to purchase at least one property selected from the at least one property that is to be disposed, (e) marketing the at least one property that is to be disposed of to prospective purchasers and (f) contacting the present owner of the at least one property that is to be disposed requesting formation regarding whether the present owner is interested in one or more services selected from loan modification, short sale, payment in exchange for surrender of the at least one property that is to be disposed of in exchange for a financial incentive.

In yet another embodiment, a method of loss mitigation and disposal of real-estate related assets is provided. The method comprising (a) receiving and storing on a computer readable medium at least minimum bid and location information regarding at least one property that is to be disposed of from a lender having an interest in the property that is to be disposed, (b) receiving and storing on a computer readable medium an offer to purchase at least one property selected from the at least one property that is to be disposed from a prospective purchaser, (c) receiving and storing on a computer readable medium information regarding a deposit provided to lender if offer to purchase at least one property is accepted by lender, (d) electronically providing information to the lender regarding the offer to purchase at least one property selected from the at least one property that is to be disposed and (f) contacting the present owner of the at least one property that is to be disposed via mail or email requesting formation regarding whether the present owner is interested in one or more services selected from (1) loan modification, (2) short sale, payment in exchange for surrender of the at least one property that is to be disposed of in exchange for a financial incentive.

In an aspect of at least one embodiment of the present disclosure, the present owner of the at least one property is in default on the at least one property that is to be disposed of.

In an aspect of at least one embodiment of the present disclosure, the method further comprises prequalifying the prospective purchaser to purchase the at least one property that is to be disposed of and the prospective purchaser made an offer on.

In an aspect of at least one embodiment of the present disclosure, the method further includes offering to the present owner in default one or more additional incentives selected from the group of (1) avoiding foreclosure and (2) avoiding deficiency judgment.

In an aspect of at least one embodiment of the present disclosure, the method further includes providing to the bank information regarding the average or appropriate minimum bid price for the at least one property that is to be disposed of.

In an aspect of at least one embodiment of the present disclosure, the method further includes providing information to the prospective purchaser that their offer to purchase at least one property selected from the at least one property that is to be disposed was rejected.

In an aspect of at least one embodiment of the present disclosure, the method further includes providing information to the prospective purchaser that their offer to purchase at least one property selected from the at least one property that is to be disposed was outbid by another prospective purchaser and giving the prospective purchaser an opportunity to submit a higher or stronger offer to purchase the at least one property.

One of the benefits of the present disclosure, is that is provides systems and methods for on-line bidding of pre-foreclosure and foreclosure assets versus having to go to the Court House to purchase the asset through a foreclosure sale.

Another benefit of the present disclosure is that it directs more potential purchasers to the assets being sold, which cause them to be sold more quickly with reduced carry cost and for a higher price than traditional foreclosure actions.

Yet another benefit of the present disclosure is that it increases the sale velocity of the assets and thereby decreases loss severity to the lender.

Yet another benefit of the present disclosure is that it greatly optimizes the marketplace for the lender's assets by providing increased advertising and consumer awareness at little to no cost to the lender.

Yet another benefit of the present disclosure is that it provides potential buyers with a one-stop shop to easily find and gather information and enter into a contract for a potential property. For example and not by way of limitation, the present disclosure provides title, appraisal and debt information regarding a particular property, along with information regarding the debt and minimum or asking bid requested or desired by the owner of the property (or soon to be owner if the property is being foreclosed on) in one convenient place.

Yet another benefit of the present disclosure is that it provides potential buyers with relevant information regarding assets in any geographic location.

Yet another benefit of the present disclosure is that it provides potential buyers with the ability to search through the assets based on many different criteria (e.g., price, bedrooms, square feet, garage, floors, amenities, view, schools, or location).

Yet another benefit of the present disclosure is that it provides Lender and MLS property information for the asset to the potential buyer.

Yet another benefit of the present disclosure is that it provides revenue streams from service orders and advertisements using the methods and systems described herein.

Yet another benefit of the present disclosure is that it provided additional security and profits to the lender because the prospective buyer has to put down earnest money (percentage of property) to bid.

In at least one embodiment of the present disclosure, the amount of the earnest money deposit is any amount that the property owner (e.g., lender) determines to be the minimum earnest money deposit (e.g., 5% of the initial offer price).

Yet another benefit of the present disclosure is that in at least one embodiment, a loss mitigation method and/or portal are provided where additional information is provided by the owner/seller of the property and additional information is obtained from prospective buyers to attract more prospective buyers and obtain the best price possible for the seller.

Yet another benefit of the present disclosure is the ability of a potential buyer to order other products and services related to the purchase (e.g., title reports, lending, additional photos).

Yet another benefit of the present disclosure is that it provides a lender interface and reports to manage their assets through the process.

Yet another benefit of the present disclosure is that it provides potential buyers the ability to bid on multiple properties, and the interface to manage those bids.

Yet another benefit of the present disclosure is that it utilizes Pay-Pal and other identifiable platforms for funds transfers.

### DRAWINGS

The above-mentioned features and objects of the present disclosure will become more apparent with reference to the following description taken in conjunction with the accompanying drawings wherein like reference numerals denote like elements and in which:

FIG. 1 shows a screen shot of a Home Owner Support Portal in accordance with at least one embodiment of the present disclosure.

FIG. 2 shows a screen shot of an account sign up screen in accordance with at least one embodiment of the present disclosure.

FIG. 3 shows an exemplary screen shot displaying a loss mitigation tool in accordance with one embodiment of the present disclosure.

FIGS. 4A and 4B show a screen displaying a financial application for assistance in accordance with one embodiment of the present disclosure.

FIG. 5 shows a screen on which a homeowner can manage the loss mitigation process on their property in accordance with one embodiment of the present disclosure.

FIG. 6 shows a screen on which a homeowner and realtor can update required documents and save to portal in accordance with one embodiment of the present disclosure.

FIG. 7 shows a communication area where the homeowner, servicer/lender and realtor can communicate in accordance with one embodiment of the present disclosure.

FIG. 8 shows a flow chart illustrating the homeowner portal in accordance with one embodiment of the present disclosure.

FIG. 9 shows a screen displaying the marketplace portal in accordance with one embodiment of the present disclosure.

FIG. 10 shows a search screen in accordance with one embodiment of the present disclosure.

FIG. 11 shows search results in accordance with one embodiment of the present disclosure.

FIGS. 12A and 12B show a property detail screen in the homeowner portal in accordance with one embodiment of the present disclosure.

FIG. 13 shows the bidder registration screen in accordance with one embodiment of the present disclosure.

FIG. 14 shows a flow chart illustrating the system's function in accordance with one embodiment of the present disclosure.

FIG. 15 shows the realtor login screen in accordance with one embodiment of the present disclosure.

FIG. 16 shows the realtor registration screen in accordance with one embodiment of the present disclosure.

FIG. 17 shows the realtor portal screen in accordance with one embodiment of the present disclosure.

FIG. 18 shows a property detail screen in the realtor portal in accordance with one embodiment of the present disclosure.

FIG. 19 shows a flow chart illustrating the realtor portal in accordance with one embodiment of the present disclosure.

FIG. 20 shows the lender login screen in accordance with one embodiment of the present disclosure.

FIG. 21 shows the lender main menu screen in accordance with one embodiment of the present disclosure.

FIG. 22 shows the accounts pending review search screen in accordance with one embodiment of the present disclosure.

FIG. 23 shows the accounts pending review search results in accordance with one embodiment of the present disclosure.

FIG. 24 shows the lender reports screen in accordance with one embodiment of the present disclosure.

FIG. 25A shows a Lender Executive Summary in accordance with one embodiment of the present disclosure.

FIG. 25B shows a Lender Shortsales Monthly report in accordance with one embodiment of the present disclosure.

FIG. 25C shows a Lender Detail report in accordance with one embodiment of the present disclosure.

FIG. 26 shows a flow chart illustrating the lender portal in accordance with one embodiment of the present disclosure.

FIG. 27 shows a pricing matrix in accordance with at least one embodiment of the present disclosure.

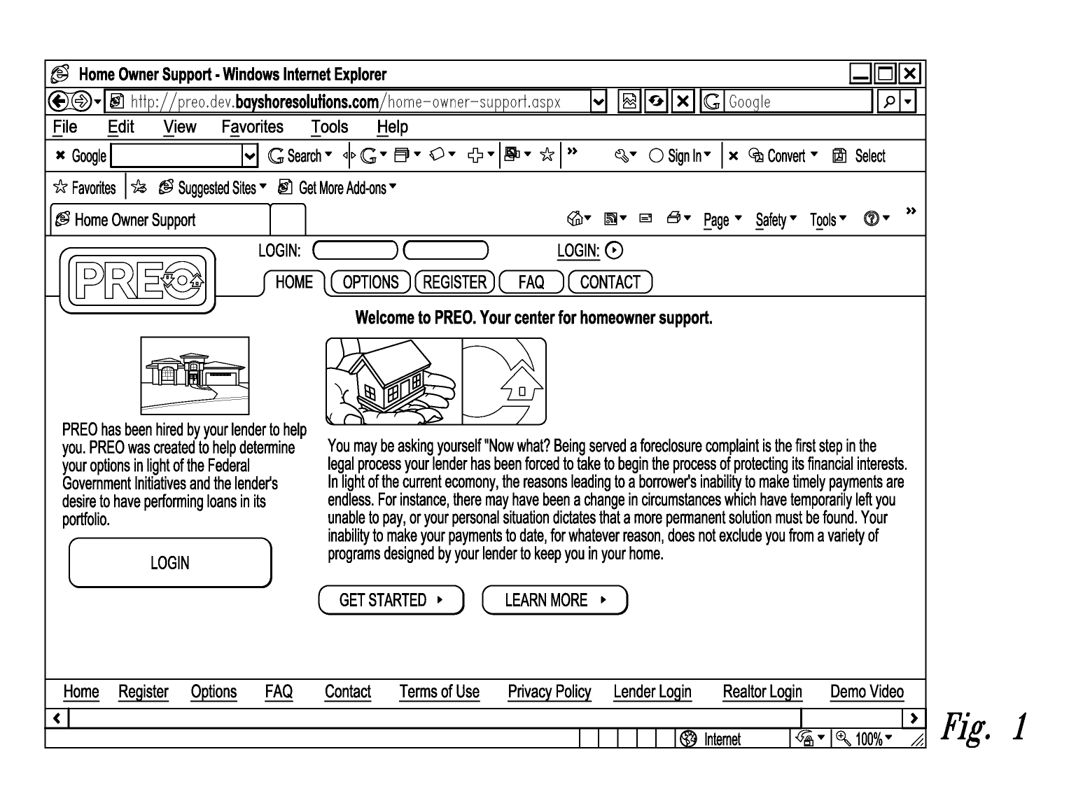

### DETAILED DESCRIPTION

PREO consists of a series of “portals.” Each of these portals is a gateway for the different audiences involved in the non-performing real estate arena. The portals utilize different methods and systems designed to lead to relevant information customized in its presentation and unique in its audience. PREO, as a loss mitigation system and method, contains a borrower portal referred to as the Homeowner Support portal. The borrower, currently in default due to non-payment of her debt obligation(s), receives trademarked correspondence directing the borrower to the PREO Homeowner Support portal. Through the use of a registration identifier unique to the borrower and investor, the client and subject loan(s) are identified. PREO's Homeowner Support portal collects all necessary information for borrower evaluation for each of the loss mitigation methods acceptable to the servicer, lender or government agency and provides a direct communication source between the default borrower, PREO staff, and the bank, servicer or investor. Once the lender or servicer evaluates the loss mitigation options for specified viability with the application of a proprietary system, the appropriate response is communicated to all Parties via PREO.

PREO coordinates the preparation of any required documents, using the data derived to facilitate the appropriate loss mitigation solution and uses its unique process and system to forward same electronically to the borrower for execution. PREO systematically maintains a unique log of the documents executed by the borrower and affords the law firm designee the opportunity to perform quality control in a customized queue for said purpose. It should be appreciated that one of the benefits of the present disclosure, in at least one embodiment, is that all the documents used as part of the methods and systems described herein can be uploaded electronically thereby reducing employee expenses and the cost of selling the property.

PREO's Lender portal brings a system and method to the tracking and analyzing of every step of the loss mitigation, finance and disposition process for non-performing real estate assets. PREO allows lenders to communicate data using a customized data file which populates the PREO system creating a “dynamic marketplace.” PREO's system has a unique lender, servicer, investor or governmental login which directs the particular user to their sequestered data. PREO's system allows the lender to view the documents which have been received in the loss mitigation process, review and apply valuation methodologies to the asset, view the interactive call log which tracks all client communication and assimilate critical path and value data in customizable reports.

PREO provides the lender with a system for comparing all of the loss mitigation methods employed and to determine the most financially successful of those methodologies. Additionally, PREO allows the lender a unique opportunity to provide documentary evidence to local foreclosure counsel in the presentation of borrower utilization of the system to the courts. In this way, PREO uniquely creates persuasive evidence to minimize the costs of litigation or mediation.

PREO's Realtor portal provides a method and system for realtors representing default borrowers attempting to sell their property as a short sale prior to foreclosure to present offers and enable the decision-making process. The Lender portal shepherds the realtor through the approval process and offer acceptance with the bank, servicer and investor. PREO allows for agent registration, provides a platform to submit required documentation for offer consideration, review the necessary documents of a short sale, communicate with the parties to the transaction and track the critical dates to the closing.

In one aspect of the present disclosure, the Realtor Portal provides a uniform and singular communication portal that allows all parties to a subject transaction the ability to monitor the status, enter notes, upload documents, report critical dates, and track the overall process of the short sale offer process. The transparent nature of the tracking and assimilation of info for submission to the lender for consideration is beneficial to the realtor, the default borrower, the potential buyer, and the lender itself. The automated platform reduces turn time for short sale decisions as well as reduces lender overhead needed to process the short-sale offers collectively creating an environment to procure short sale transactions in the most efficient manner possible.

PREO's unique system queues documents in such a way that they are listed sequentially in order of importance for review by the agent. PREO allows the agent to monitor the communication associated with the documents. PREO sets up the method and system to handle critical dates throughout the process and ultimately set closing date expectations that preserve the integrity of the contract.

PREO's Marketplace portal creates a marketplace which heretofore did not exist. PREO relies on several unique marketing strategies and search methodologies, which gives a third-party buyer clarity along with the supporting due diligence and the tools necessary to successfully acquire a distressed asset. PREO allows a third-party buyer to search for a property serving as the collateral for an active mortgage foreclosure action, as well as bank owned assets referred to as real estate owned “REO” properties in an innovative environment.

PREO's Buyer Portal allows a Buyer to make offers to purchase via online bids for or offers to buy properties in the foreclosure process or post sale. The Portal provides an online escrow and buyer account module and a methodology to present qualifying offers to participating lenders and servicers. In one embodiment of the present disclosure, the method maintains escrow accounting and application of funds functionality for single or multiple property acquisition.

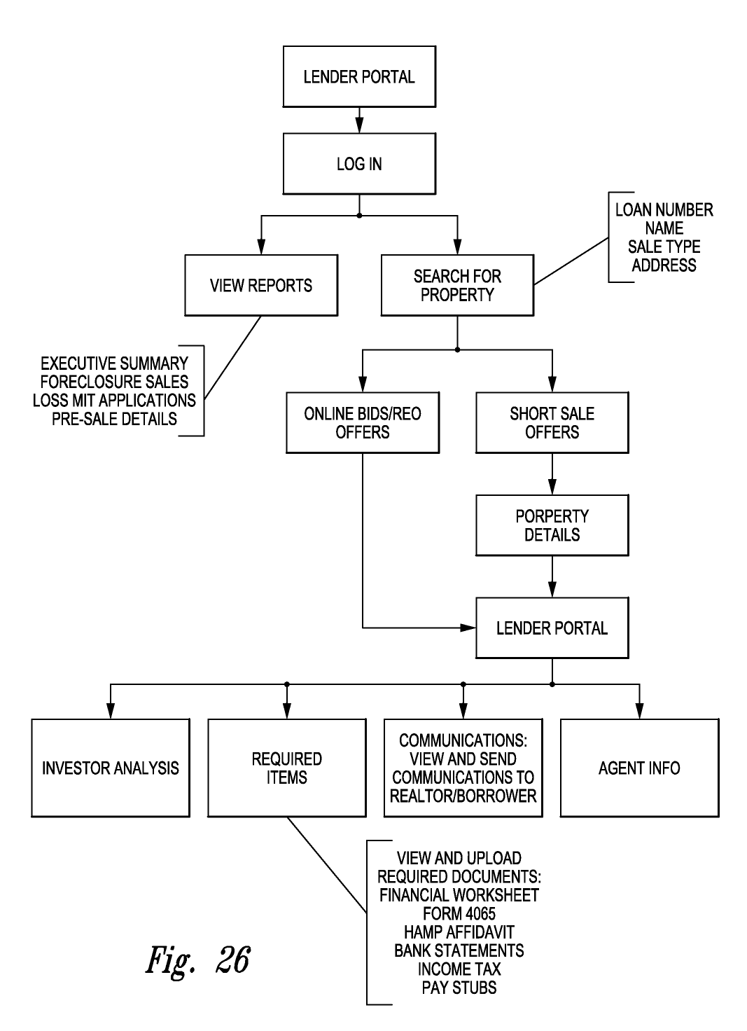

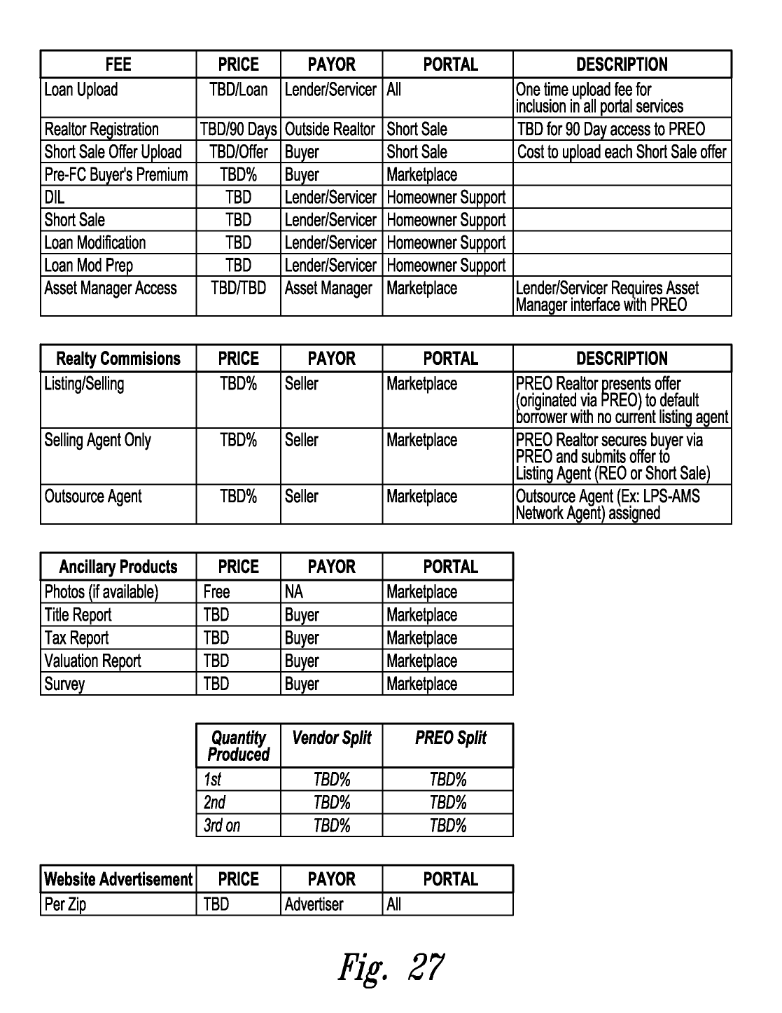

The present disclosure provides all relevant data to screen and evaluate the subject property. That is, the disclosure accumulates, title, valuation, photographic, tax and other relevant property in a manner which facilitates appropriate property acquisition research. The disclosure tracks the status of the pending foreclosure action as well as the progress of multiple bidders, updates bidding progress and provides electronic notification of important events. The disclosure also provides the lender with key metrics on the properties being evaluated, the loss on sale and the type of potential consumer for each property. The disclosure works with the Lender or Servicer and imports the loan data necessary to provide the marketplace with up to date efforts of the defaulting party which may result in a property being removed from bidding. The present disclosure provides a financing link and data collection designed to assist bidders with financing an acquisition. It should be appreciated the another benefit and advantage of the present disclosure is the ability to create and provide pricing information and/or a pricing model that tells the owner of the property (e.g., lender) that the assets should be priced differently based on the information, interest and offers that the have from prospective buyers and, optionally, information they have from the seller or owner being foreclosed on. See, e.g., FIGS. 26A, 26B, 26C and 27. It should also be appreciated that the present disclosure provides the benefit that it provides pre-approvals and pre-approval information to the buyers and sellers, which eliminates or at least discourages any unqualified buyers and generates profits from the mortgage company that provides the loan and provides necessary and valuable underwriting information to the mortgage entity providing financing. It also provides the potential purchaser with financial options the party acquiring the property.

With all of PREO's portals sharing a common database, PREO uniquely links the borrower in distress with the third-party bidders. In one embodiment of the present disclosure maintains varying privacy rules to protect the integrity of the information provided to the particular user, tracks all of the uses and data paths chosen by the users, provides quantitative and qualitative metrics for the chosen solution, increases the property turn through key strategic marketing, provides all necessary tools to evaluate the solution chosen and finances the acquisition.

Finally, PREO provides transparency to consumers seeking loss mitigation, foreclosure or REO properties with a unique tutorial and animated product demonstration.

The methodology and systems disclosed herein not available in the current marketplace.

PREO can be built using any web language with a data storage and retrieval system. The web interface needs to be built in such a way that the data can be called and displayed on the web page. Web pages would be built for the general user to search the data storage, based on the criteria selected and display the data in a clear and concise manner. Additional pages are added to allow the user to look at individual records in detail.

Web pages are used to accept user registration information and then pass the data storage for retention. More pages are used to call, from the data storage, specific registered user information such as active bids, watch items, and account data. There needs to be web pages to allow the user to change that information, and save it to the data storage.

Reports are built, using any reporting tool or web language, to display statistical information to clients. This data will be pulled from the data storage.

Web pages are built to upload, using a preferred transfer protocol, documents from various users. These documents will need to be stored, using any storage method, and displayed as needed via web page, or any other document viewer.

Web pages need to be built to electronically transfer money, using a third party plug in or directly with a financial institution. A web page will be used for the user to view, modify and manage their funds.

Back end programs will need to be built, using any programming tool or language, for data transfers from and to clients and other third parties. These file transfers can use any method or protocol.

Email communication, using any email product, needs to occur between all parties using the web site.

Web pages will be used to show third party plug-ins. These third party plug-ins will be used and called based on their individual requirements. Accounts and agreements may be required to implement said plug-ins. In one aspect of at least one embodiment of the present disclosure, the web pages are written in ASP.NET, AJAX, C++ or related language, Visual Basic Script and/or Java Script.

In another aspect of at least one embodiment of the present disclosure, the leverage web services and SOAP technology or related technology are used to push and pull information from and to the methods and systems described herein.

In another aspect of at least one embodiment of the present disclosure, Google Maps, Zillow, Authorize.Net services are used to provide some of the features and benefits of the at least on embodiment of the present disclosure.

The method and systems to of communicating via the internet or World Wide Web are well known in the art and it should be appreciated that they can be used to perform the methods and systems disclosed herein.

In another aspect of at least one embodiment of the present disclosure, file delivery is accomplished via SFTP to a PREO folder location.

In another aspect of at least one embodiment of the present disclosure, a complete default marketplace is provided that increases traffic to properties, standardizes advertising, maximizes the sale process and provides opportunities for loss mitigation along the way. Advertising and traffic to properties is achieved by maximizing current legal advertising taking place every working day in every MSA, by driving traffic via Google, Yahoo and MSN and by direct advertising to defaulting borrowers through the service process and to the general public through a direct mail interface with the servicers' database.

In another aspect of at least one embodiment of the present disclosure, a pre-foreclosure opportunity approval tool is provided. A homeowner will get a pre-foreclosure letter from their servicer/lender letting them know about the methods and systems described herein and their benefits and the web site location where they can use the methods and systems described herein. The web site location or portal (could be referred to as the Home Portal) contains a workflow to help manage the process of liquidating the asset before going to foreclosure. The homeowner is validated through property information loaded from a LPS file feed. Any changes to the LPS desktop are updated to PREO within the hour.

In another aspect of at least one embodiment of the present disclosure, SFTP: Secure File Transfer Protocol is used and the XML file format that is matched with an XSD for validation. It is uploaded hourly and loaded into the SQL Database.

In another aspect of at least one embodiment of the present disclosure, a Lender/Servicer XML data file is created. The file contains all Pre-Foreclosure and REO loans from lenders/servicers. In another aspect of at least one embodiment of the present disclosure, the file delivery is via SFTP to a PREO folder location for each lender/servicer.

In another aspect of at least one embodiment of the present disclosure, the XML file format that is matched with an XSD for validation.

In another aspect of at least one embodiment of the present disclosure, the XLM is uploaded hourly and loaded into the SQL Database.

In another aspect of at least one embodiment of the present disclosure, a MLS CVS data file is provided. This file contains MLS data for all areas in which PREO has properties. File delivery can be via SFTP to a PREO folder location for MLS. File format can be CSV (Comma Separate Variable) and the file is uploaded daily into the SQL Database.

In another aspect of at least one embodiment of the present disclosure, the data from the CVS data file is matched to Pre-Foreclosure and REO data by property address.

In another aspect of at least one embodiment of the present disclosure, the service documents are ordered (e.g., Title, Pictures, Taxes, Appraisal, and Survey).

In another aspect of at least one embodiment of the present disclosure, the buyer/investor has ability to request these documents.

In another aspect of at least one embodiment of the present disclosure, the once requested, an email is sent to the appropriate vendor to create the document and when completed, the vendor will email the requestor with the document attached/incorporated.

In another aspect of at least one embodiment of the present disclosure, documents are manually uploaded to the buyer's profile and sent e-mail notification to Buyer/User. Customer payments can be handled through Authorize.net, ACH and/or Pay Pal or their equivalent.

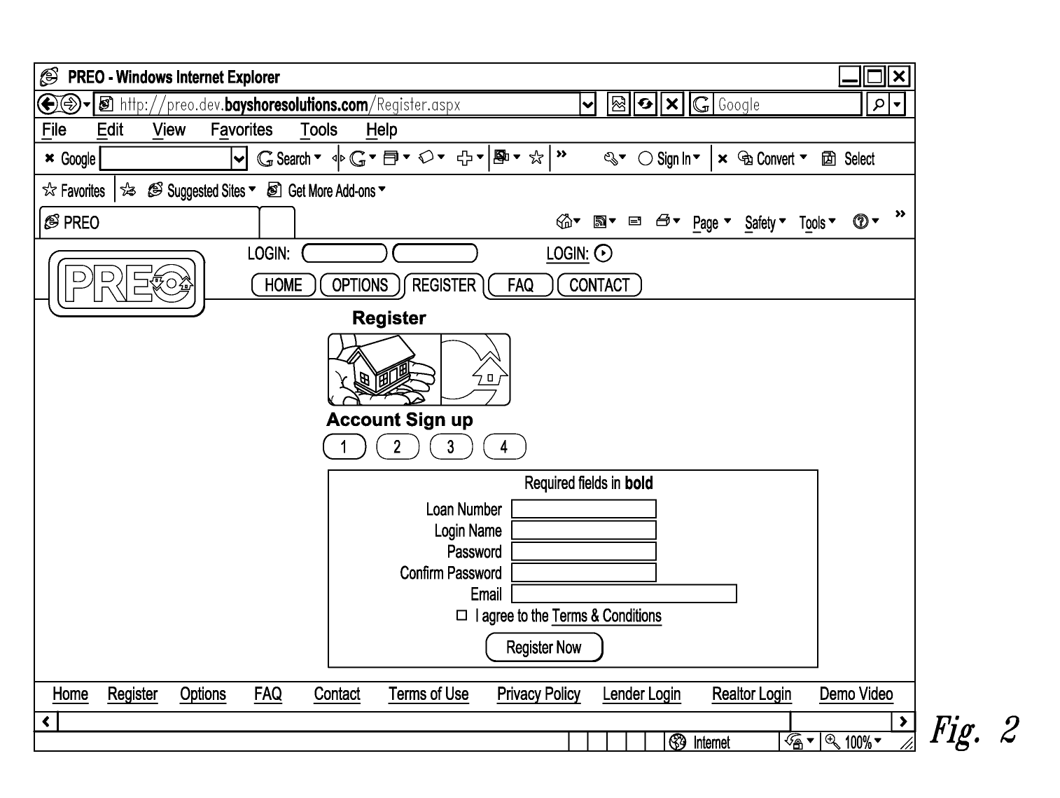

FIG. 2 demonstrates one exemplary embodiment of the PREO Home Owner portal is a pre-foreclosure opportunity approval tool. Homeowner will get a pre-foreclosure letter from their servicer/lender letting them know about PREO and the web site location. Home Owner Support portal contains a workflow to help manage the process of liquidating the asset before going to foreclosure. Homeowner is validated through property information loaded from the appropriate file feed. Any changes to desktop are updated to PREO within the hour. The process simplifies and standardizes the loss mitigation process. Help servicer/lender expedite liquidation process.

Provides an easy platform to loss mitigate the property stopping negative reporting of credit data, the possibility of deficiency and providing cash for keys and access.

FIG. 2 demonstrates one exemplary embodiment of the how the homeowner can register to leverage the methods and systems of the PREO system described herein.

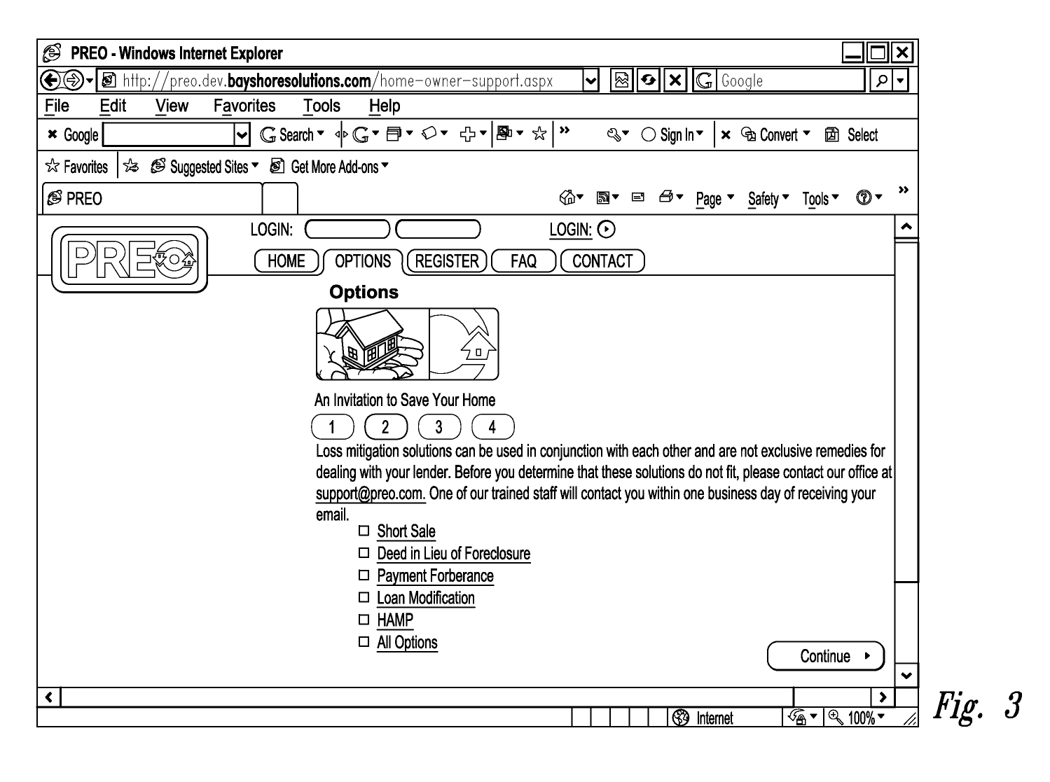

FIG. 3 demonstrates one exemplary embodiment of the loss mitigation tool to help educate the homeowner on the options available and inform servicer/lender which option(s) the homeowner is interested in. This allows the lend to concentrate on home owners they know are interested in the various loss mitigations options available The lender can quickly get appropriate loss mitigations groups involved to better assist the home owner. This outward looking proactive process saves a lot of time and money for the lender because it gets the defaulting barrower involved quickly and determines what the barrower's interest is and allows the system/method to act according.

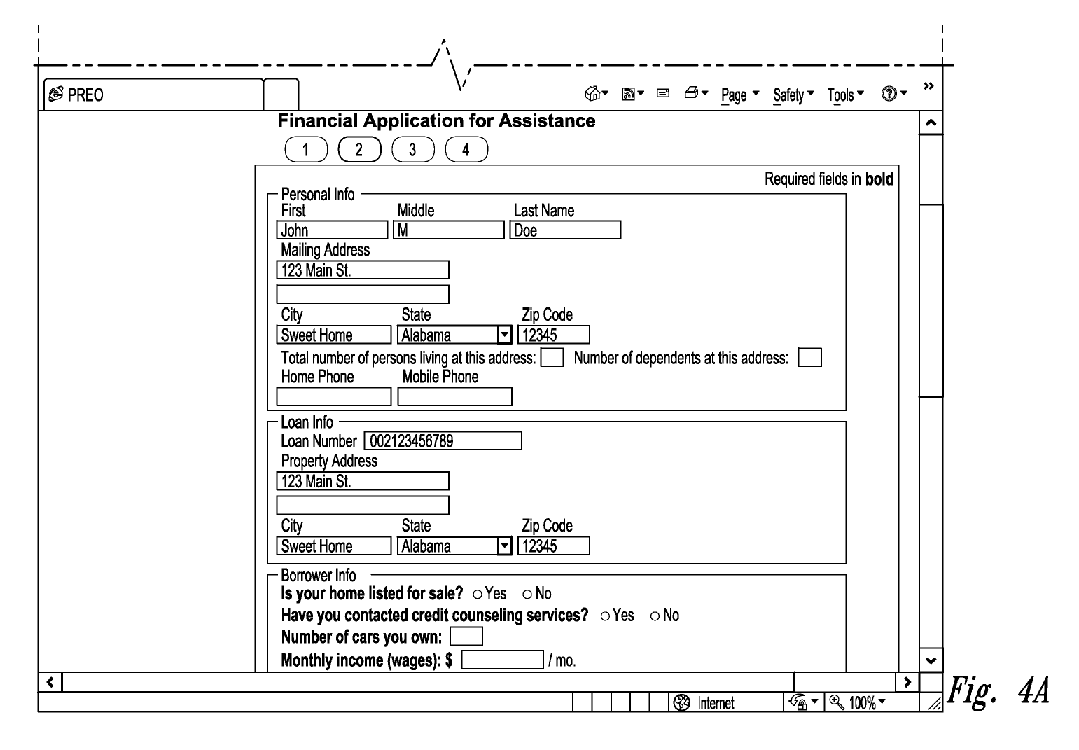

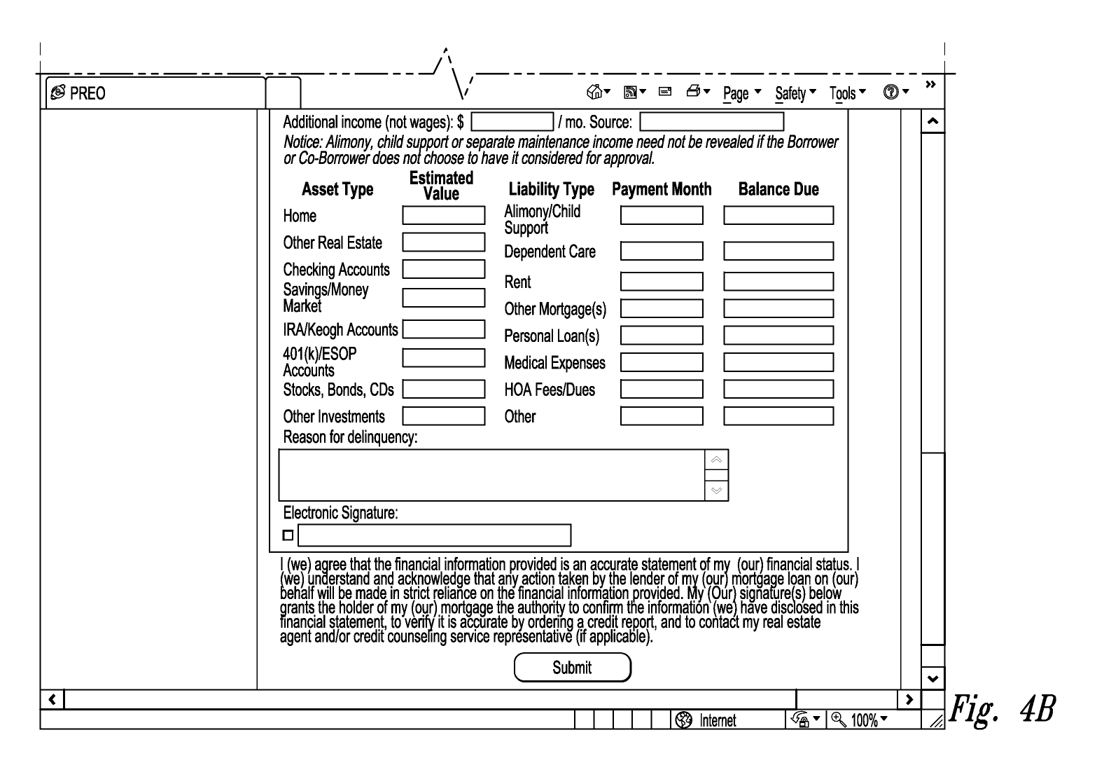

FIGS. 4A and 4B demonstrates one exemplary embodiment of how the homeowner can enter financial information that is captured in PREO database and use of a standard and consistent financial worksheet. Lender can have access to homeowner information to better vet loss mitigation options.

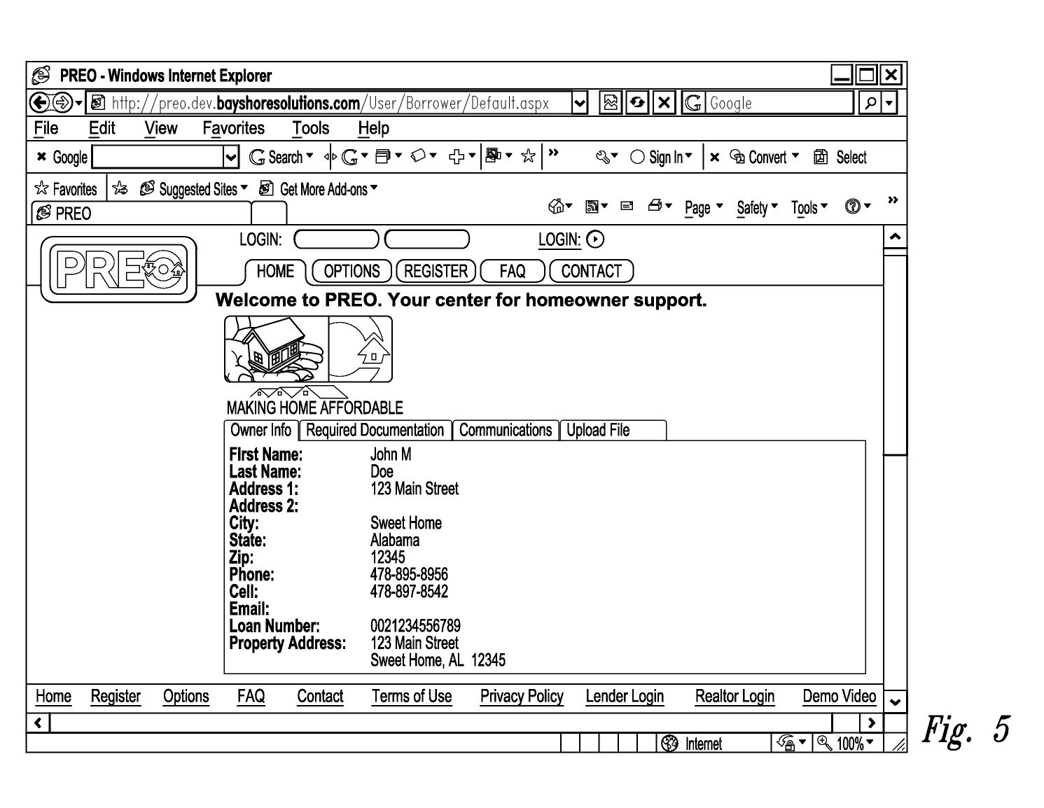

FIG. 5 demonstrates one exemplary embodiment of the central repository for homeowner to manage the loss mitigation process on their property. The realtor can have access to this view to better assist the homeowner. The servicer/lender will have access to review this portal to better assist the homeowner in making a loss mitigation decision.

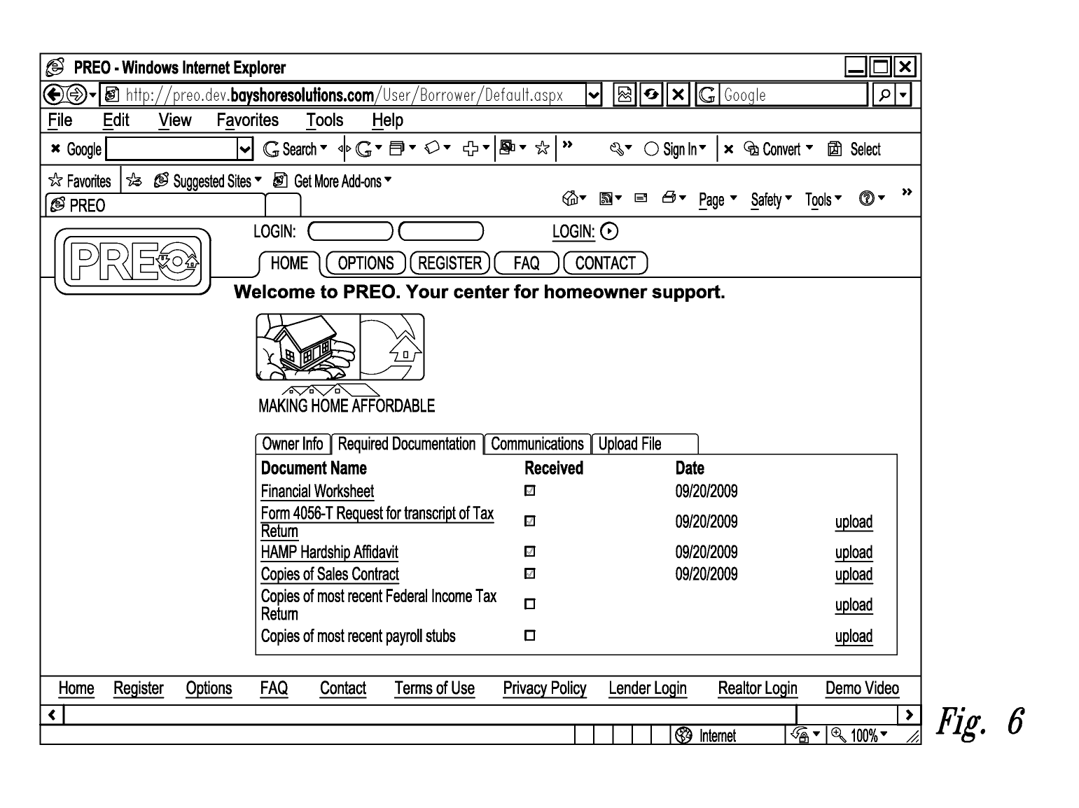

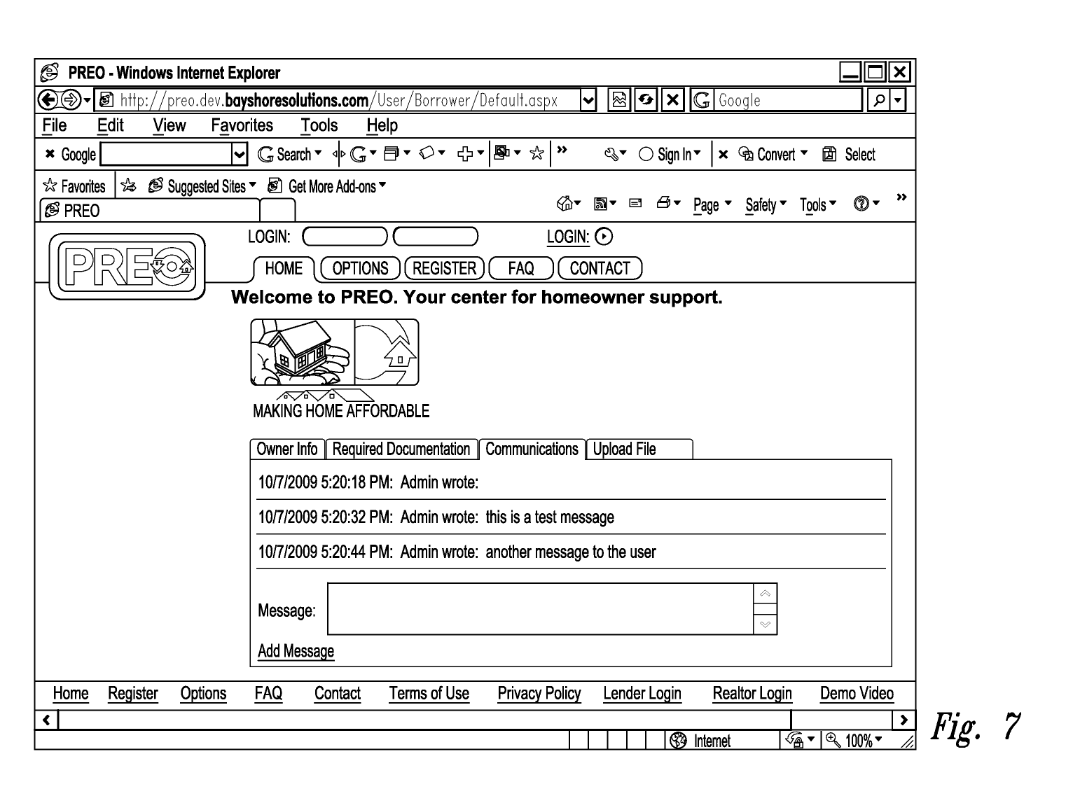

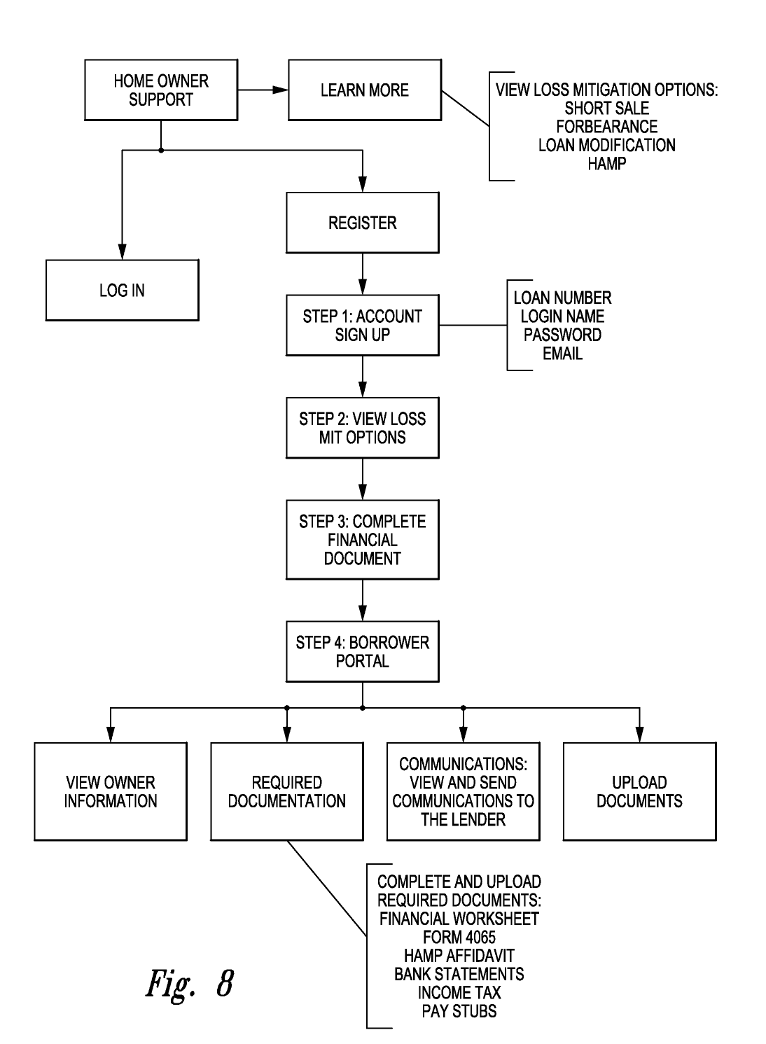

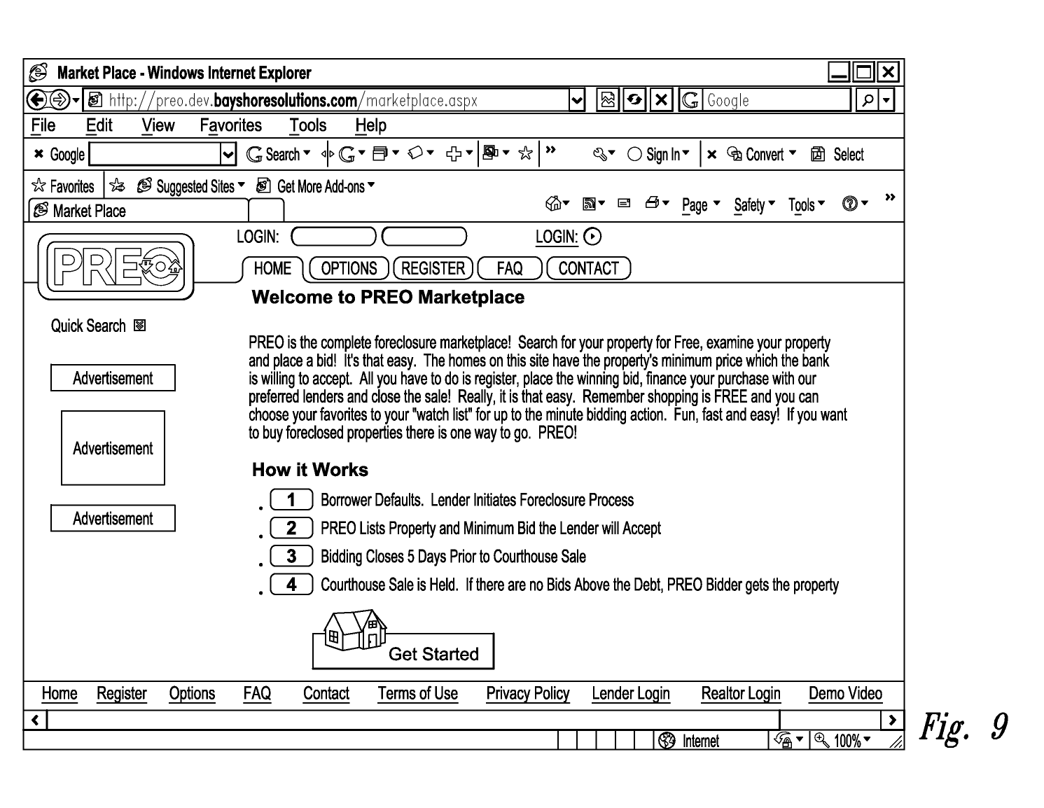

FIG. 6 demonstrates one exemplary embodiment of the present disclosure where the homeowner and realtor can update required documents and save to portal. In one aspect, the realtor can only see update status/completions. This provides transparency of process and documents required for loss mitigation and standardized documents to reduce confusion.

In another aspect of the present disclosure, all forms and documents are available on the Home Owner portal for Home Owner servicer/lender to download. It should be appreciated that the old way was to fax/mail documents in and this will reduce confusion over lost documents that were faxed at different times and time spent trying to find all of those documents. This also reduces homeowner and realtor calls to servicer/lender by increased clarity of process, consistent process and required documents for loss mitigation option.

It should be appreciated that the addresses the difficulties lenders experience in meeting ever-changing investor and governmental guidelines and to reduce loss severity while tracking the results in a meaningful way is provided by the methods and systems of the present disclosures.

FIG. 7 demonstrates one exemplary embodiment of a communication area where the homeowner, servicer/lender and realtor can communicate and all communication is documented and stored and servicer/lender can attain an extract of the communication tab. It should be appreciated that these features can be useful in court to help prove why may not need mediation and to help show how servicer/lender tried to work with the homeowner on loss mitigation options.

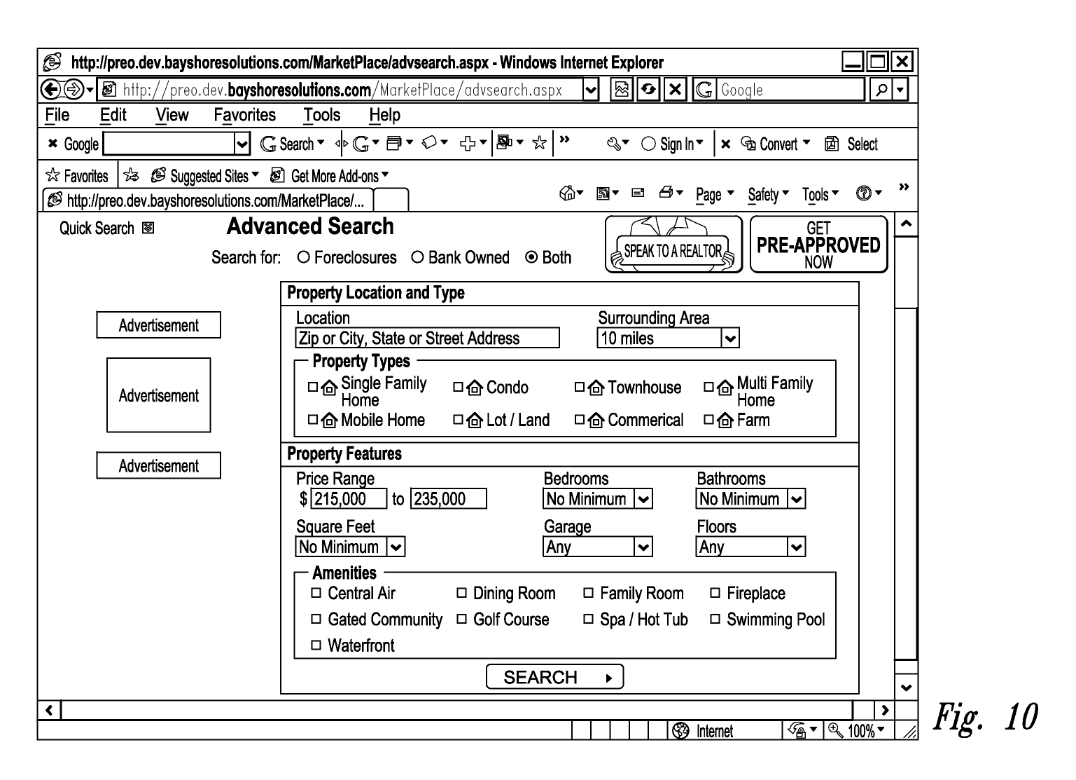

FIG. 10 demonstrates one exemplary embodiment of the simplifies the process of easily searching on pre-foreclosure and REO properties where buyer can place bids on pre-foreclosure properties and does not need a 100% financing as they would at a foreclosure court sale. It should be appreciate that the PREO “Marketplace” portal increases loss mitigation opportunity by providing a platform through its direct mail and on-line to complete a “cash for keys and inspection” program. Additionally, the portal brings more eyes to the property and assists in getting a purchaser more quickly and at a higher price.

As a result, the servicer/lender increases the sale velocity and thereby decreases loss severity. They also gain a great advantage in the optimization of the marketplace for its properties with the increased advertising and consumer awareness at no cost. The Marketplace portal capitalizes on advertising revenue.

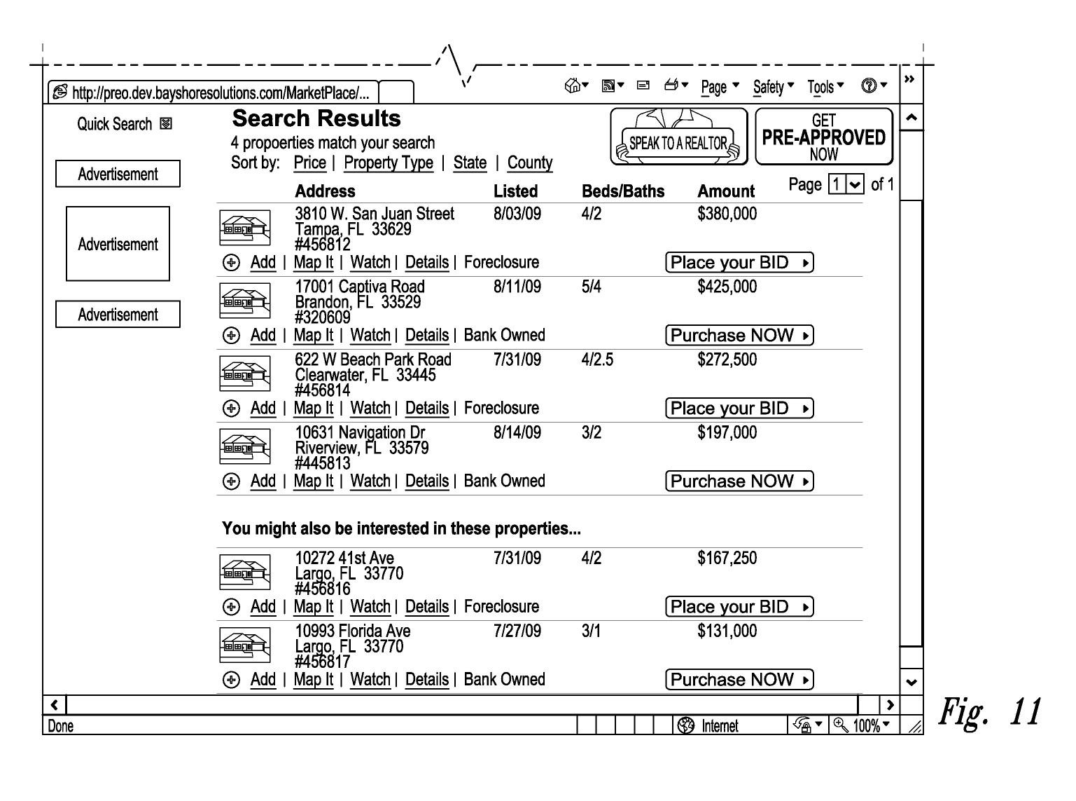

FIG. 11 demonstrates one exemplary embodiment of the searches of all PREO properties. PREO has pre-screened and realtors and mortgage brokers to assist buyer with the acquisition of a property. This also provides the ability to pre-approve buyer/investor for mortgage and provide search results contains LPS, Lender and MLS property information. PREO Marketplace has a wealth of material to help buyer/investor make an informed decision. Among other things, the methods and systems provide relevant evaluation information in any geographic location and the ability to search on many different criteria (e.g., price, bedrooms, square feet, garage, floors, amenities, etc.).

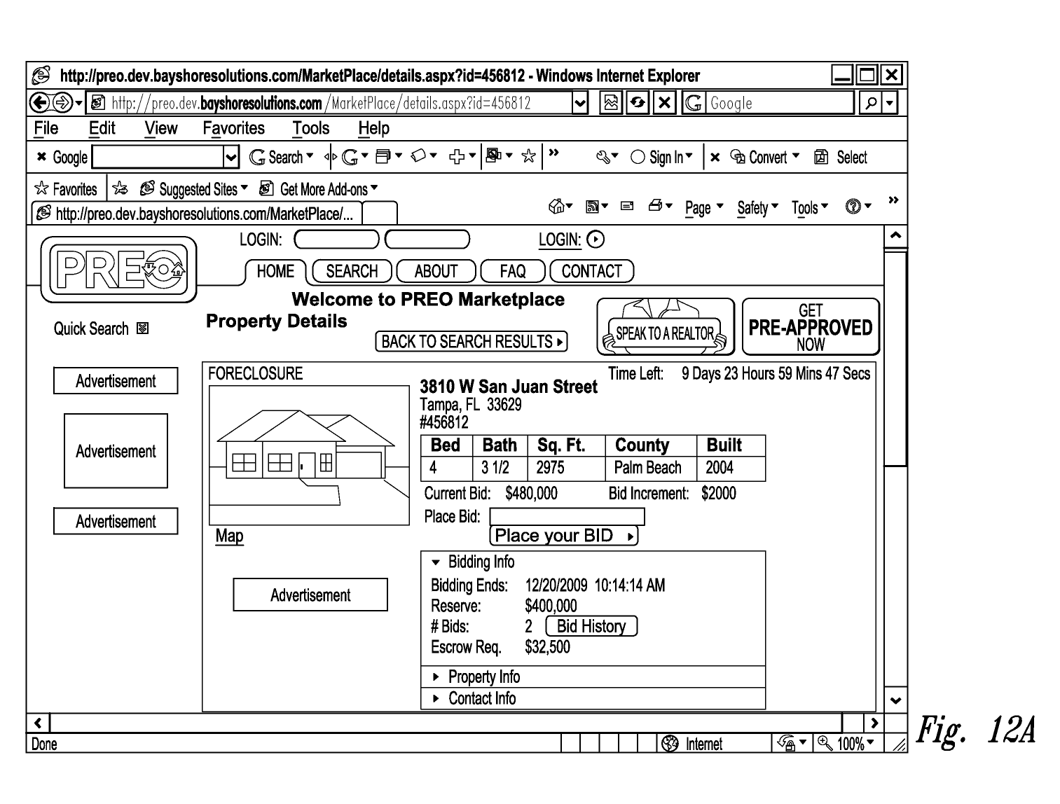

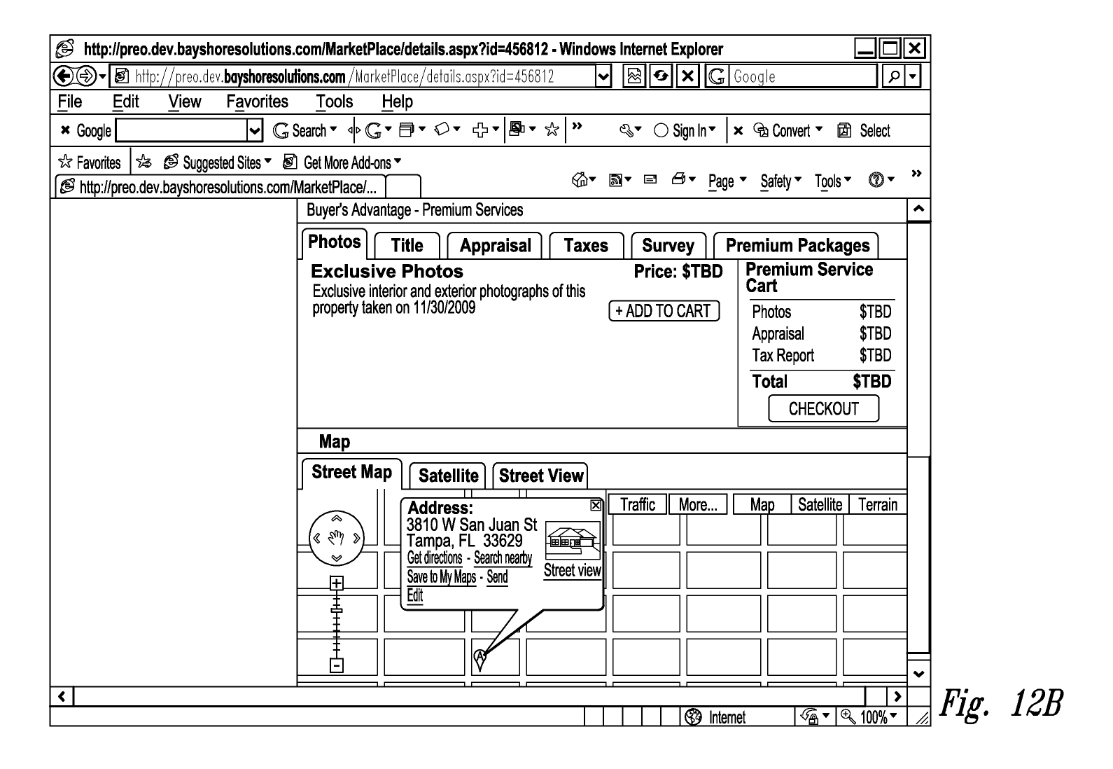

FIGS. 12A and 12B demonstrate one exemplary embodiment of the ability to add property to watch list so buyer can easily keep track of it. In one aspect, the buyer has to put down earnest money (percentage of property) to bid on pre-foreclosure or purchase REO properties. This will help vet out non-serious offers. If purchaser rescinds after offer is accepted, the earnest money deposit is forfeited and after the transaction fee to PREO the balance is remitted to the servicer/lender.

In one aspect of the present disclosure, PREO capitalizes on Paypal and other identifiable platforms; it puts the potential buyer at ease and encourages the confidence necessary to make the next acquisition on line.

FIGS. 12A and 12B demonstrates another exemplary embodiment of the PREO Marketplace provides the possibility for ancillary revenue for the servicer through arrangements with BPO, title, photograph, appraisal, inspection, and tax documents Document can be loaded to PREO where buyer can download at their leisure. PREO will have cost savings when another buyer orders the same service on the property because original document is used.

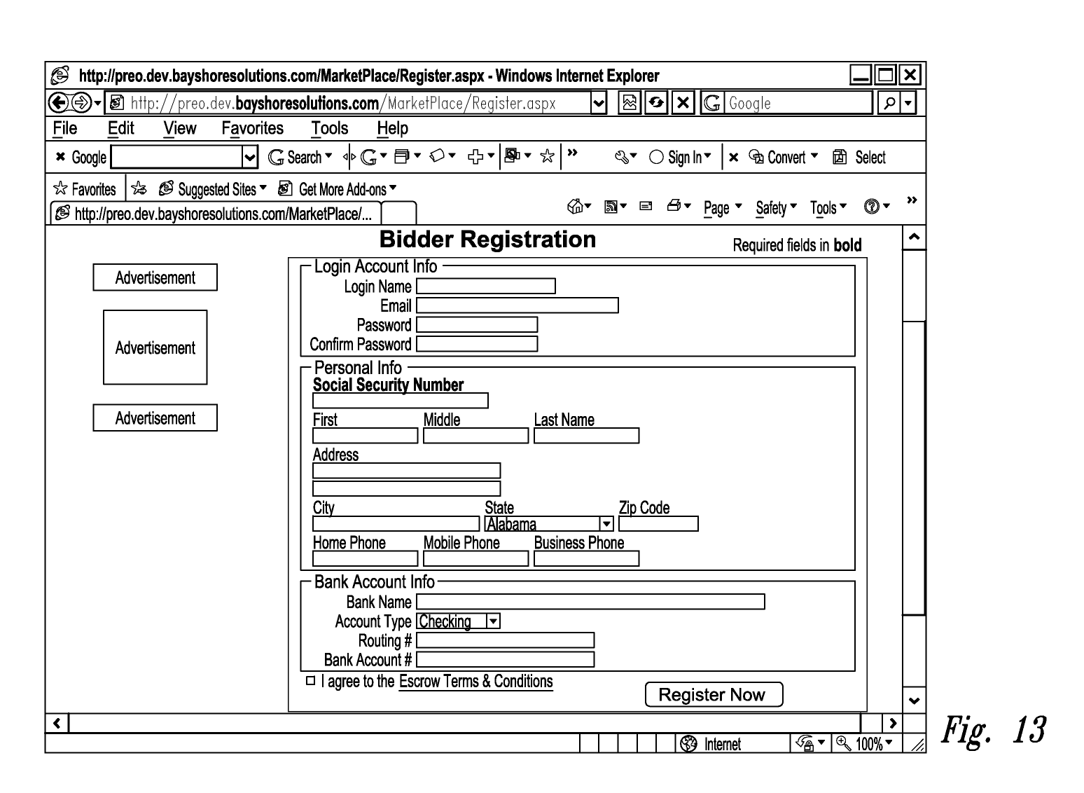

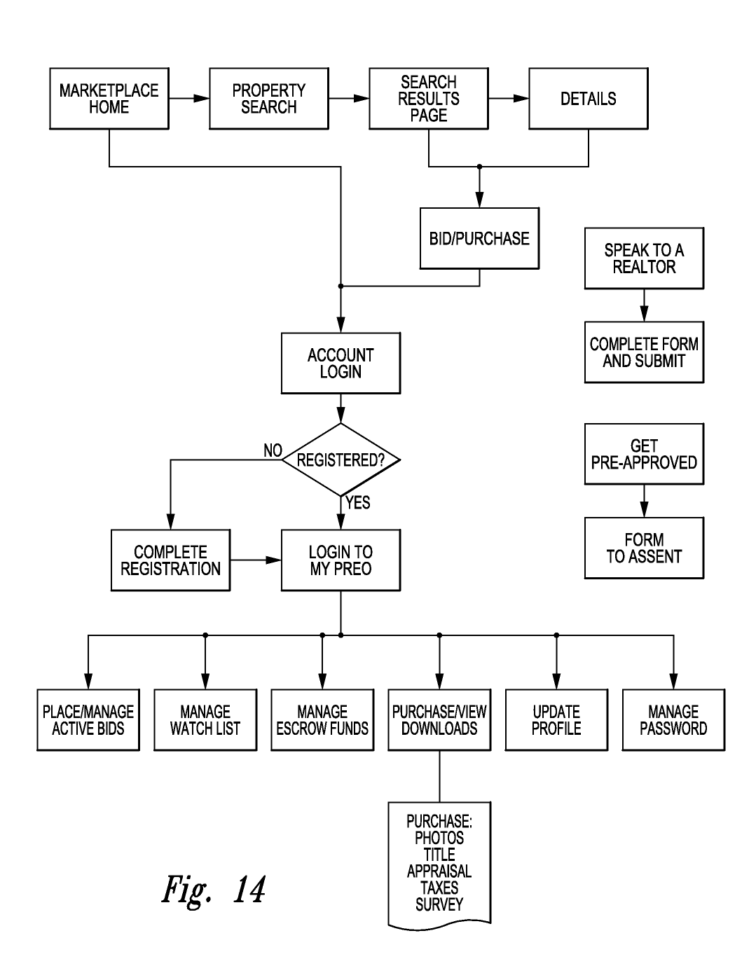

FIG. 13 demonstrates one exemplary embodiment of the A buyer will need to register before they are able to bid or purchase on a property. If a buyer goes to place a bid/purchase on a property. PREO will check to make sure buyer is registered. If not, they get redirected to the “Bidder Registration” page. Next, PREO logic will verify buyer has enough money in escrow to bid/purchase said property. PREO informs buyer amount of earnest money they need to bid/purchase. If they don't have enough money in their escrow account, they are redirected to a web page that will allow them to distribute funds into their escrow bucket.

In another aspect, once buyer has enough money in escrow to bid/purchase a property, PREO will allocate the specified earnest money from the escrow bucket to the property buyer is bidding/purchasing.

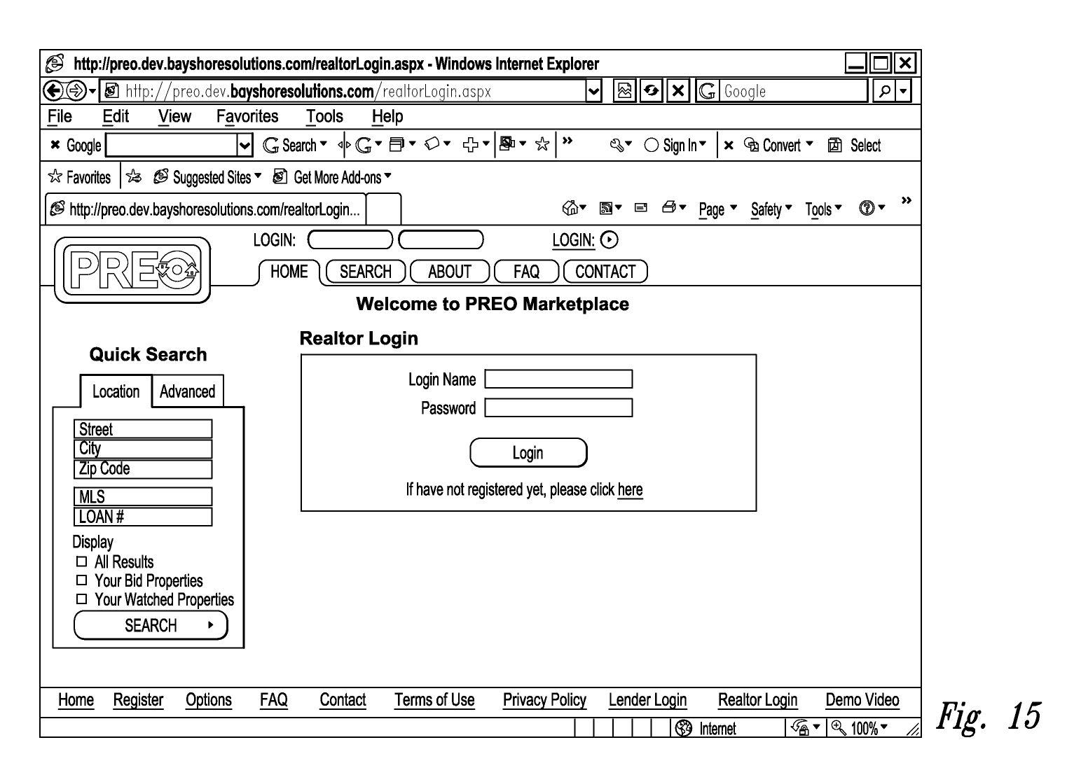

FIG. 15 demonstrates one exemplary embodiment of the PREO Realtors will assist homeowners who do not have a Realtor.

Realtors representing the homeowner will be instructed by lender/servicer that they have to utilize PREO's Portals in order to submit a Short Sale offer.

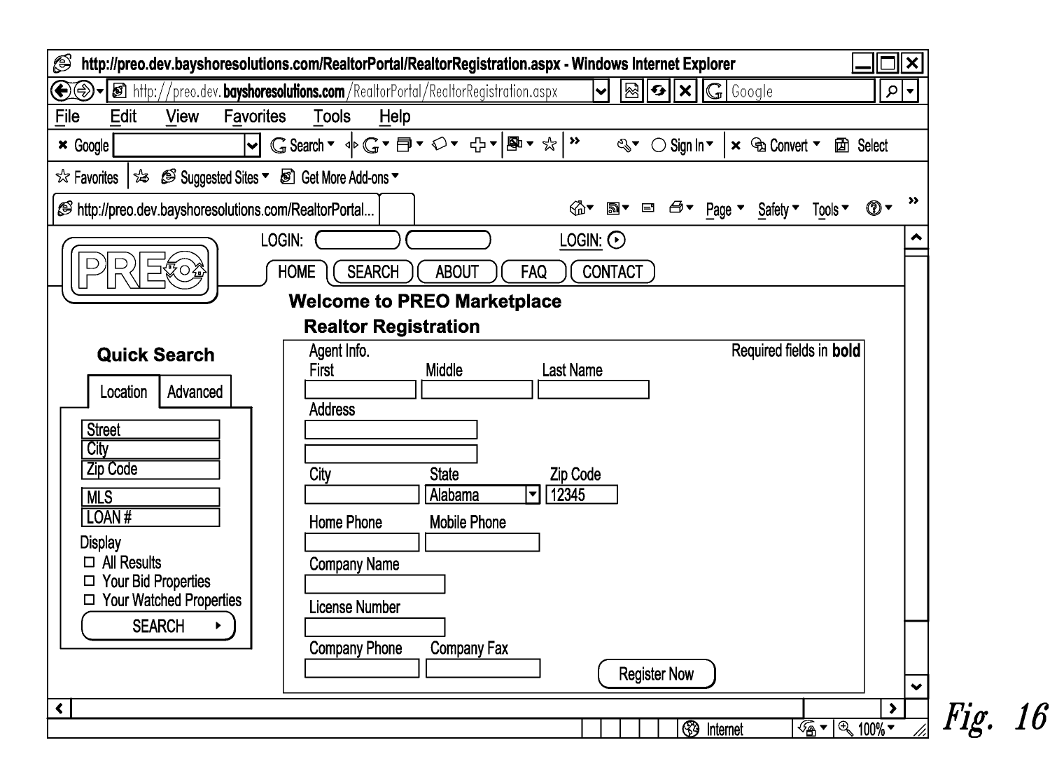

FIG. 16 demonstrates one exemplary embodiment of the Realtors will need to register to gain access to PREO. Any Realtor can register; the cost is $29 for 90-day access to PREO.

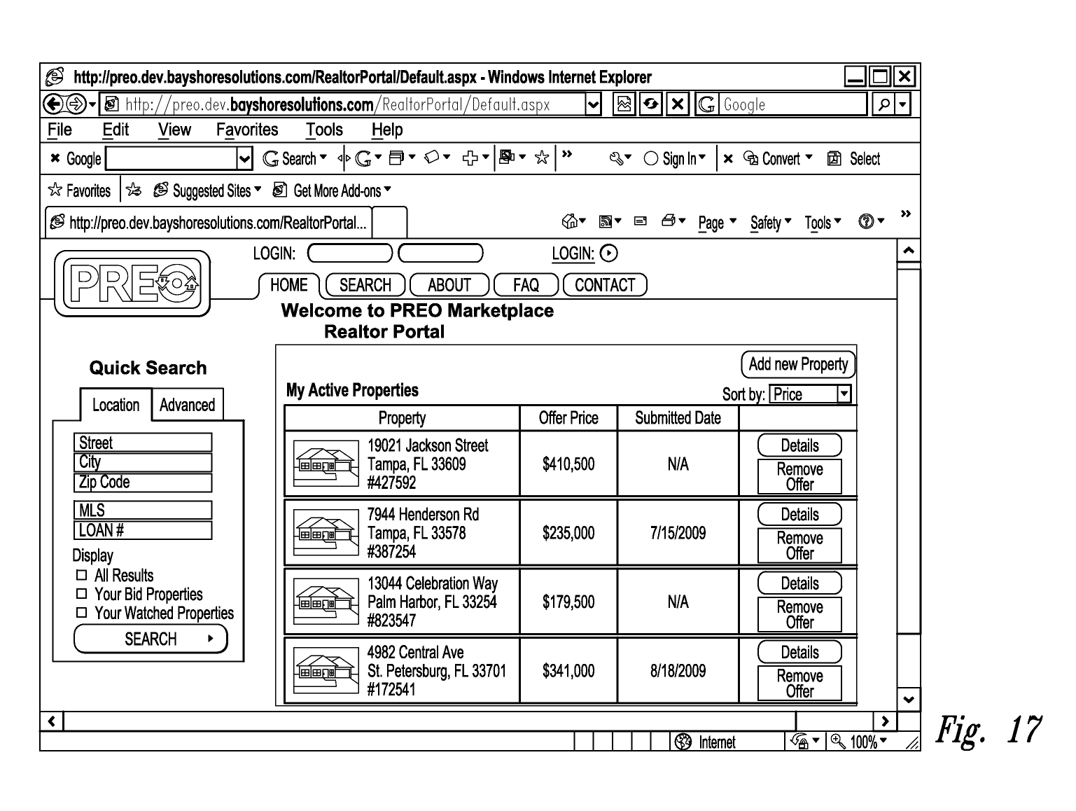

FIG. 17 demonstrates one exemplary embodiment of the Realtor will have a queue so they can easily manage their properties. They will need to add the Borrower property to their queue in order to assist them. Realtor has ability to find properties they are representing by the search functionality. They have to sign an electronic document stating they are representing the homeowner. An email is sent to the homeowner letting them know that Realtor added their property and to contact PREO Support if they have any questions. The Realtor can “Remove” property from their queue if the property is no longer available for Loss Mitigation or they are no longer representing the homeowner.

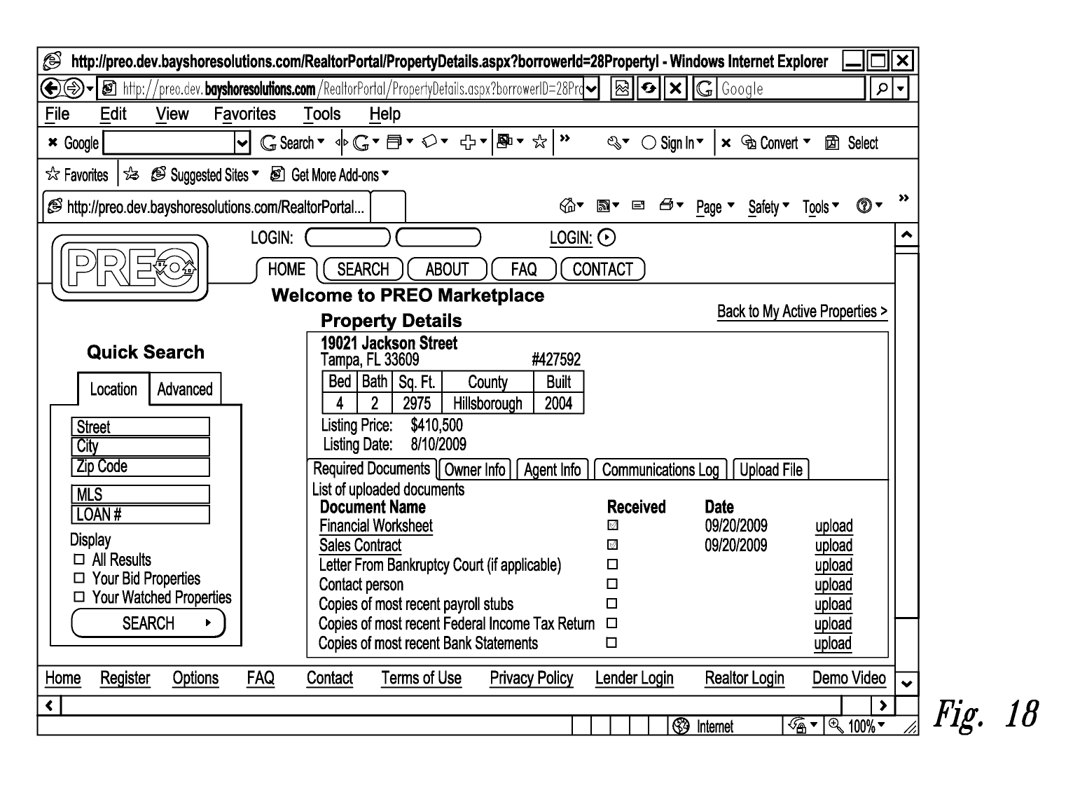

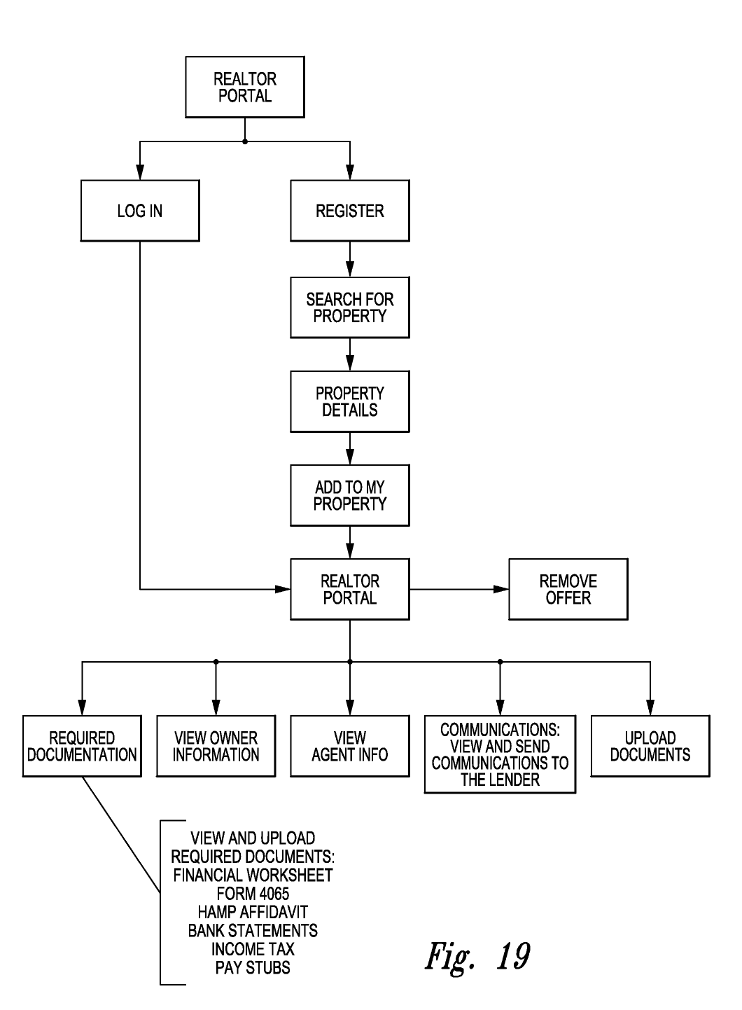

FIG. 18 demonstrates one exemplary embodiment of the present disclosure. When Realtor clicks details for a specified property, they are taken to the Home Owner Portal. The Realtor has full functionality, except they are unable to view any document uploaded on the portal. Realtor can upload all documents, see owner info, agent info, view communication log and add comments.

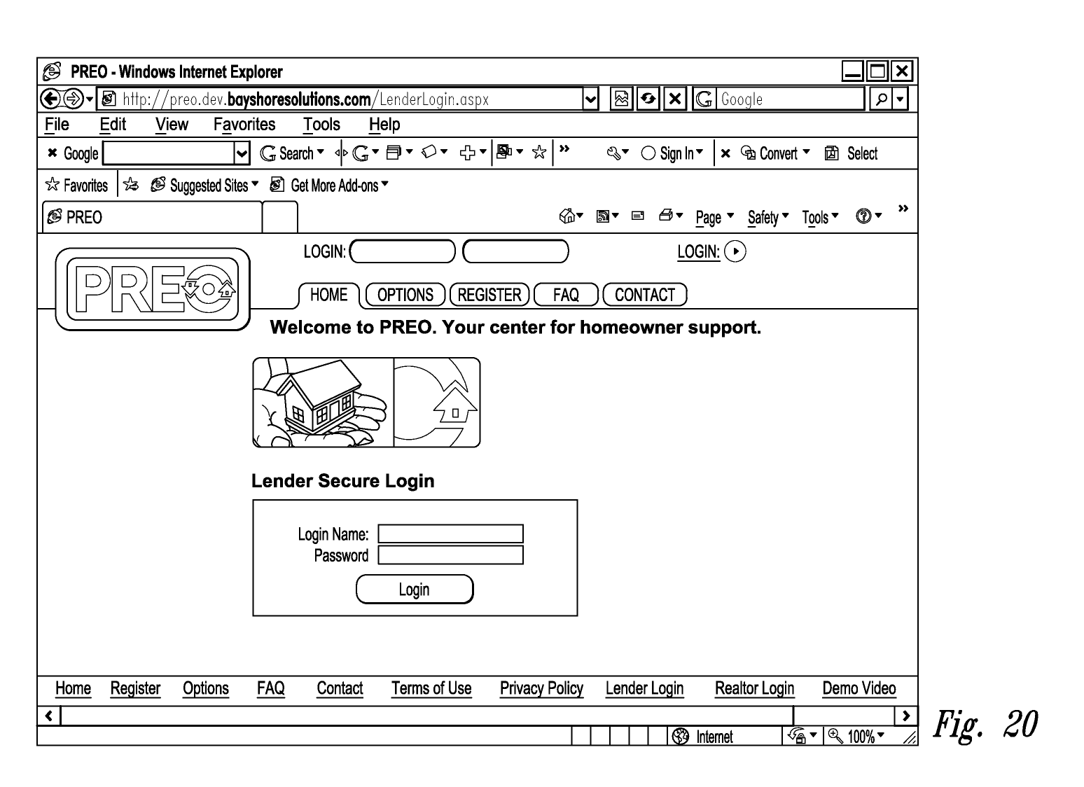

FIG. 20 demonstrates one exemplary embodiment of the lender will attain their Login and Password from PREO. There can be 3 access levels for the Lender. They analyze and work their queues for Purchases, Bids or Short Sale offers. They assign properties to the Agents' Queue for them to work. Main Lender contact for PREO helps manage the process with Lender.

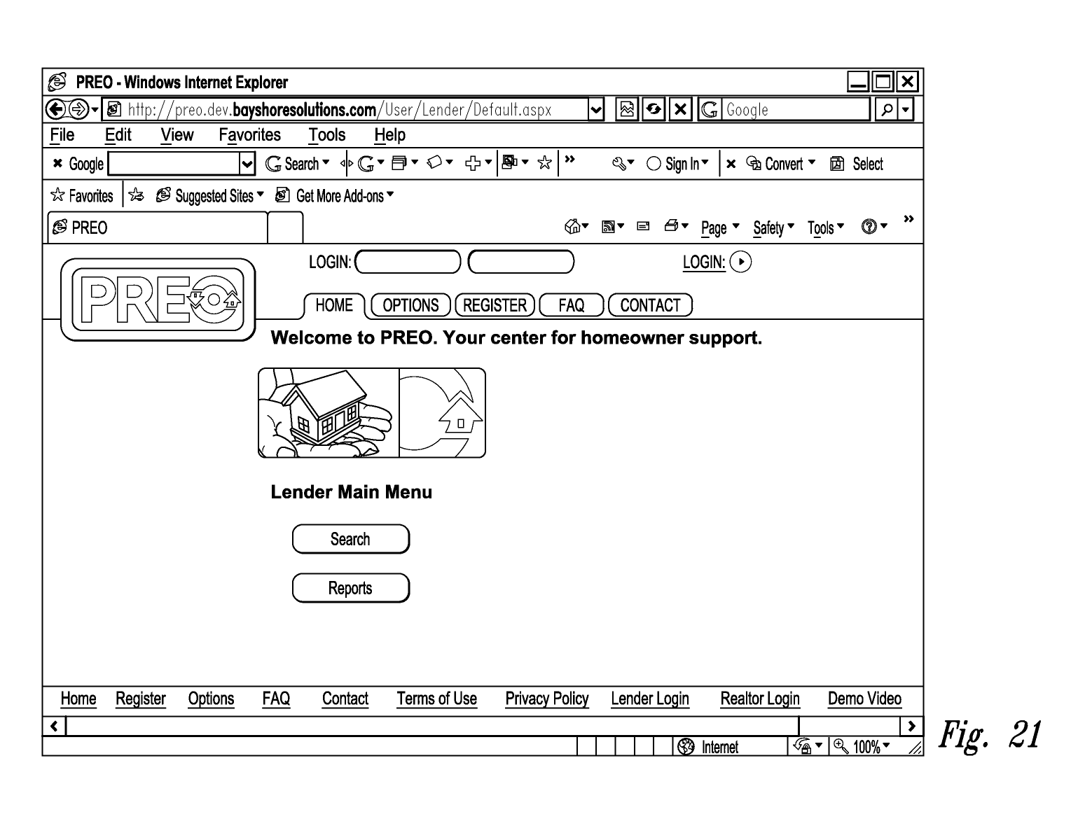

FIG. 21 demonstrates one exemplary embodiment of the Lender will have 2 main functions. They can perform various searches on their properties to better analyze the status and progression of Short Sales, Bids or Purchases on their properties. Lender will also have reporting metrics to track the portfolio at all levels to better assist them in managing these properties.

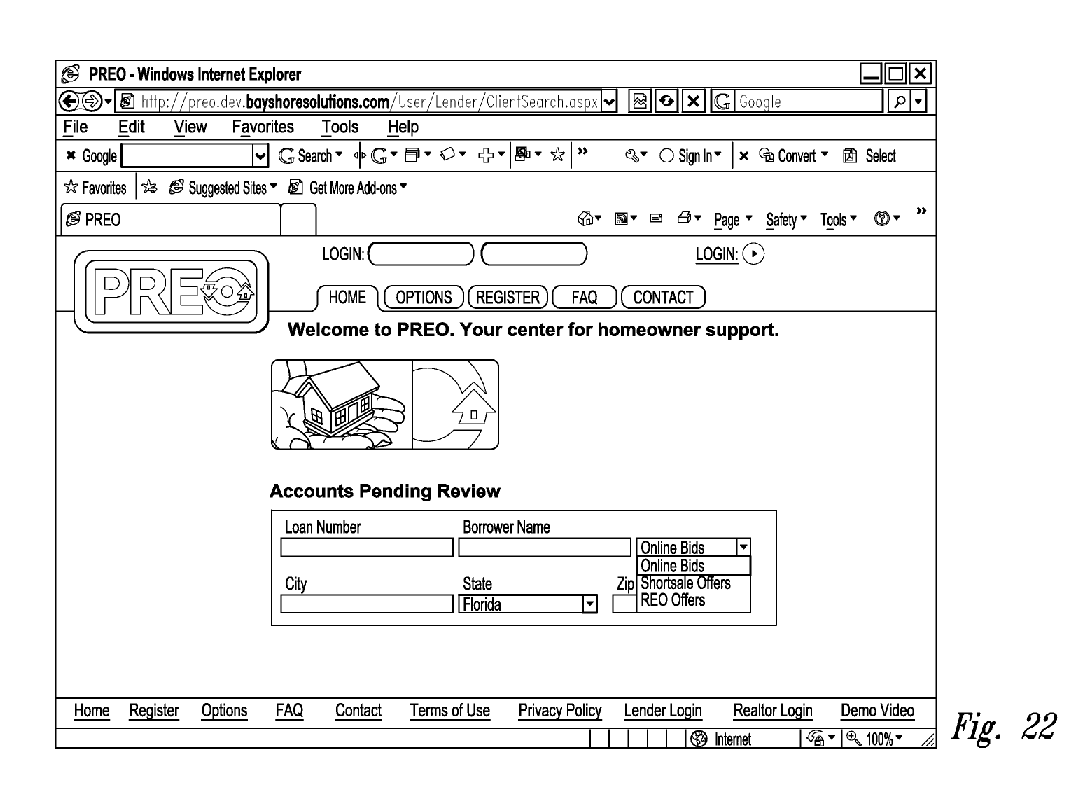

FIG. 22 demonstrates one exemplary embodiment where the lender can perform various searches to extract the desired properties they wish to view at a summary level. The main buckets are “Online Bids”, “Shortsale Offers” and “REO Offers”. They can sub define the results by entering a Loan Number, Borrower Name, City, State and/or Zip Code.

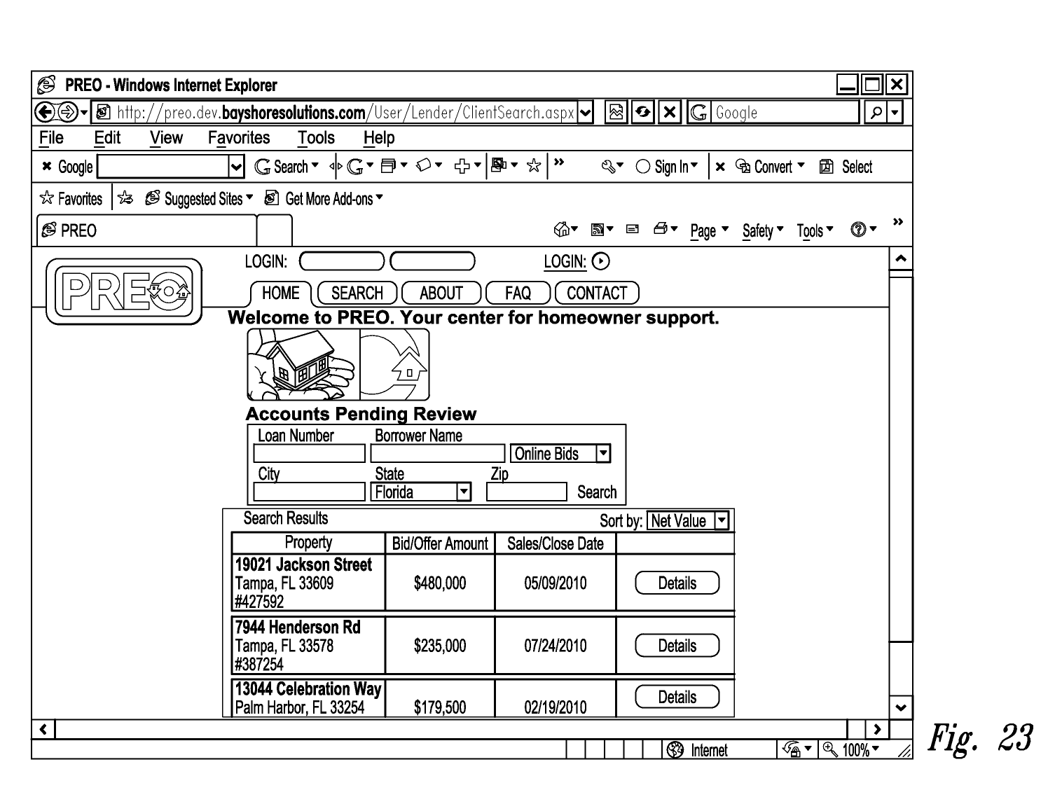

FIG. 23 demonstrates one exemplary embodiment of the Summary level of accounts pending review. If the Lender selects the “Details” for “Online Bids” or “Short Sale Offers” they will be taken to the Home Owner portal. This will allow the Lender to examine all Short Sale Offers and Bids on a specific property from one location. If the Lender selects the “Details” on a REO Offer, they are taken to the Marketplace detail for the specified property.

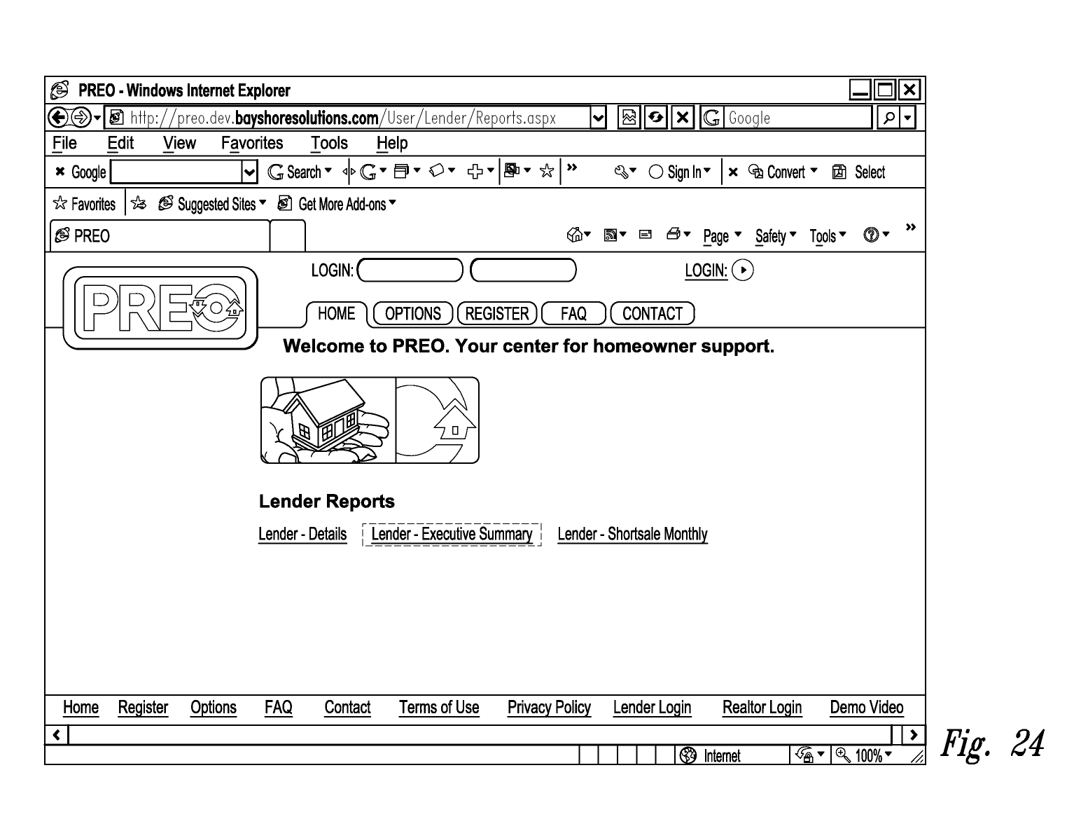

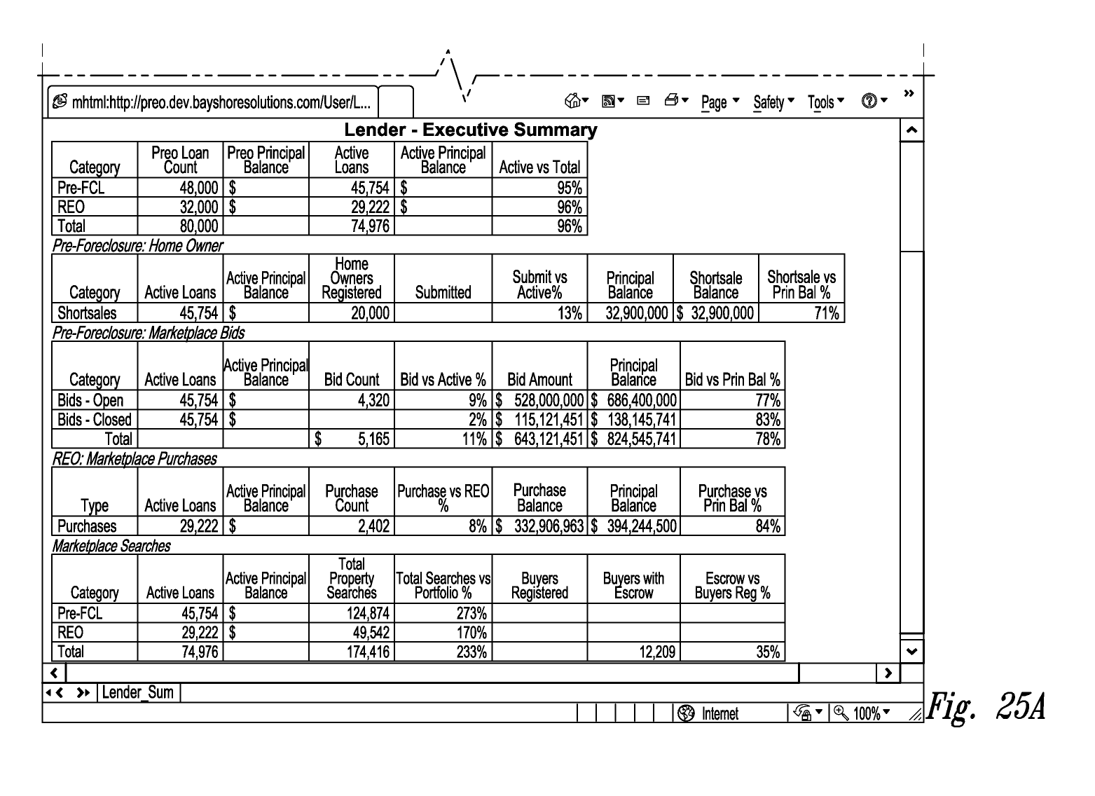

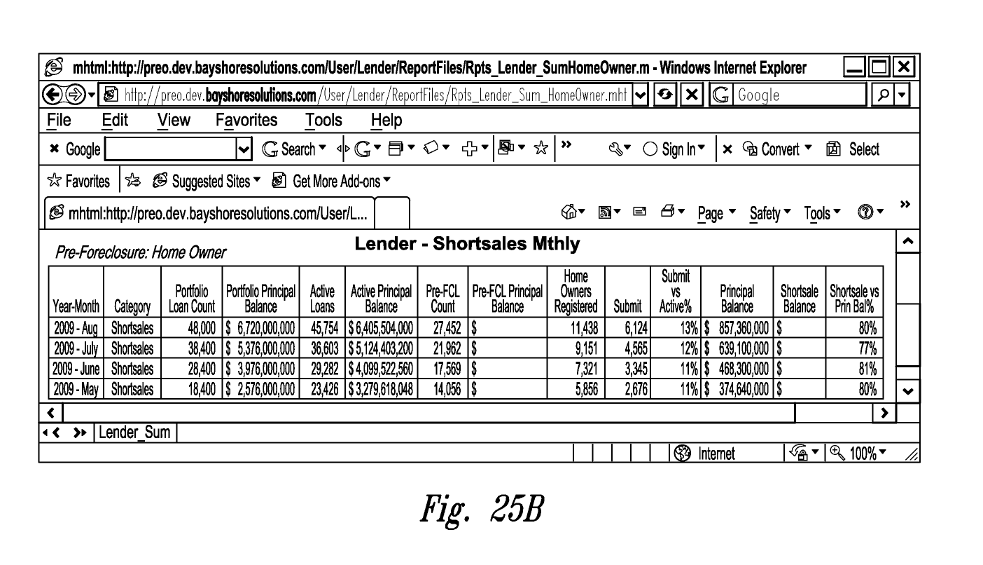

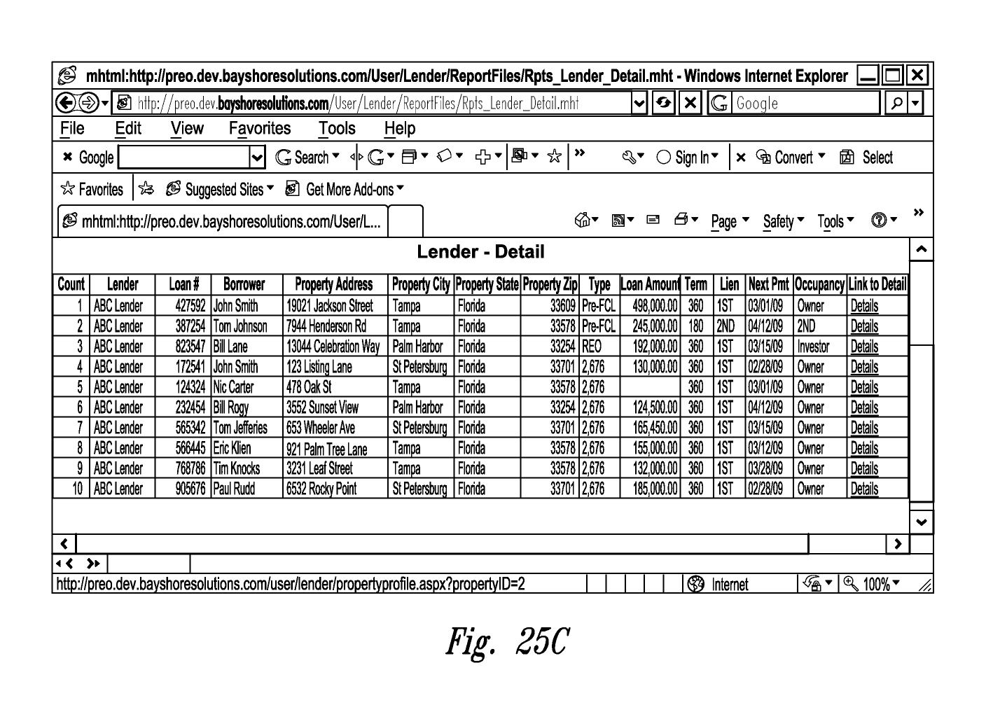

FIGS. 24, 25A and 25B demonstrates one exemplary embodiment of the 3 initial reporting metrics, Lender—Executive Summary, Lender—Lender Short Sales Monthly, Lender—Details. If buyer doesn't have enough money in their escrow account, they are redirected to a web page that will allow them to distribute funds into their escrow bucket. Once buyer has enough money in escrow to bid on a property, PREO will allocate the specified earnest money from the escrow bucket to the property buyer is bidding. If purchaser rescinds after offer is accepted, the earnest money deposit is forfeited and after the transaction fee to PREO the balance is remitted to the lender. If buyer loses or cancels a bid, their money is returned to them. Buyers don't need 100% financing to bid on a property versus need 100% at a court sale.

PREO capitalizes on pay-pal and other identifiable platforms; it puts the potential buyer at ease and encourages the confidence necessary to make the next acquisition on line.

PREO Marketplace provides the possibility for ancillary revenue for the servicer through arrangements with BPO, title, photograph, appraisal, inspection, and tax documents.

PREO will have cost savings when another buyer orders the same service on the property because original document is used.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. Method of loss mitigation and disposal of real estate related assets, the method comprising:
(a) receiving and storing on a computer readable medium at least minimum bid and location information regarding at least one property that is to be disposed of from a lender having an interest in the property that is to be disposed;
(b) receiving and storing on a computer readable medium an offer to purchase at least one property selected from the at least one property that is to be disposed from a prospective purchaser;
(c) receiving and storing on a computer readable medium information regarding a deposit provided to lender if offer to purchase at least one property is accepted by lender;
(d) electronically providing information to the lender regarding the offer to purchase at least one property selected from the at least one property that is to be disposed;
(e) marketing the at least one property that is to be disposed of to prospective purchasers; and
(f) contacting the present owner of the at least one property that is to be disposed requesting formation regarding whether the present owner is interested in one or more services selected from loan modification, short sale, payment in exchange for surrender of the at least one property that is to be disposed of in exchange for a financial incentive.

2. The method of claim 1, wherein the present owner of the at least one property is in default on the at least one property that is to be disposed of.

3. The method of claim 1, wherein the method further comprises:
(g) prequalifying the prospective purchaser to purchase the at least one property that is to be disposed of and the prospective purchaser made an offer on.

4. The method of claim 2, further comprising:
(g) offering to the present owner in default one or more addition incentives selected from the group of (1) avoiding foreclosure and (2) avoiding deficiency judgment.

5. The method of claim 2, further comprising:
(g) providing to the bank information regarding the average or appropriate minimum bid price for the at least one property that is to be disposed of.

6. The method of claim 2, further comprising:
(g) providing information to the prospective purchaser that their offer to purchase at least one property selected from the at least one property that is to be disposed was rejected.

7. The method of claim 2, further comprising:
(g) providing information to the prospective purchaser that their offer to purchase at least one property selected from the at least one property that is to be disposed was outbid by another prospective purchaser and giving the prospective purchaser an opportunity to submit a higher or stronger offer to purchase the at least one property.

8. Method of loss mitigation and disposal of real estate related assets, the method comprising:
(a) receiving and storing on a computer readable medium at least minimum bid and location information regarding at least one property that is to be disposed of from a lender having an interest in the property that is to be disposed;
(b) receiving and storing on a computer readable medium an offer to purchase at least one property selected from the at least one property that is to be disposed from a prospective purchaser;
(c) receiving and storing on a computer readable medium information regarding a deposit provided to lender if offer to purchase at least one property is accepted by lender;
(d) electronically providing information to the lender regarding the offer to purchase at least one property selected from the at least one property that is to be disposed; and
(f) contacting the present owner of the at least one property that is to be disposed via mail or email requesting formation regarding whether the present owner is interested in one or more services selected from (1) loan modification, (2) short sale, payment in exchange for surrender of the at least one property that is to be disposed of in exchange for a financial incentive.

9. The method of claim 8, wherein the present owner of the at least one property is in default on the at least one property that is to be disposed of.

10. The method of claim 8, wherein the method further comprises:
(g) prequalifying the prospective purchaser to purchase the at least one property that is to be disposed of and the prospective purchaser made an offer on.

11. The method of claim 9, further comprising:
(g) offering to the present owner in default one or more addition incentives selected from the group of (1) avoiding foreclosure and (2) avoiding deficiency judgment.

12. The method of claim 8, further comprising:
(g) providing to the bank information regarding the average or appropriate minimum bid price for the at least one property that is to be disposed of.

13. The method of claim 8, further comprising:
(g) providing information to the prospective purchaser that their offer to purchase at least one property selected from the at least one property that is to be disposed was rejected.

14. The method of claim 8, further comprising:
(g) providing information to the prospective purchaser that their offer to purchase at least one property selected from the at least one property that is to be disposed was outbid by another prospective purchaser and giving the prospective purchaser an opportunity to submit a higher or stronger offer to purchase the at least one property.
